(19) United States
(12) Patent Application Publication
(10) Pub. No.: US 2019/0225307 A1
(43) Pub. Date: Jul. 25, 2019

(54) TOWBOAT AND OPERATIONS THEREOF

(71) Applicant: Marine Technologies LLC, Mandeville, LA (US)

(72) Inventors: Jan Mikalsen, Covington, LA (US); Kjell Erik Larsen, Covington, LA (US); David C. Shirah, Jr., Madisonville, LA (US)

(21) Appl. No.: 16/167,774

(22) Filed: Oct. 23, 2018

Related U.S. Application Data
(60) Provisional application No. 62/576,016, filed on Oct. 23, 2017.

(51) Int. Cl. B63B 35/70; G05D 1/00; G05D 1/02

(52) U.S. Cl. CPC B63B 35/70; G05D 1/0016; B63B 2035/007; G05D 1/0206; G05D 1/0027

(57) ABSTRACT

An integrated tow system may include one or more unmanned towboat modules that may be used to improve maneuvering of tows on an inland waterway, such as a river. To reduce environmental stresses on operators, a command module that includes control and communications equipment for controlling operation of the unmanned towboat modules may provide living quarters for the operators, but not include a propulsion system for maneuvering a tow. The control and communication equipment may monitor for rotation commands by an operator that exceed rotational capabilities of the unmanned towboat modules, and provide for non-linear controls that include changing position of a rotational point that is centrally located longitudinally along the tow so as to provide for 1:1 rotational control of the tow by a tow drive system (e.g., bow and stern unmanned towboat modules). River tracking and river parking features may be supported by the control and communications equipment.

### RELATED APPLICATIONS

This application claims priority to co-pending U.S. provisional application having Ser. No. 62/576,016 filed on Oct. 23, 2017; the contents of which are herein incorporated by reference in their entirety.

### BACKGROUND OF THE INVENTION

History of Towboats

Marine transportation of commodities on inland waterways, such as rivers, has evolved into a unique form of towboat to better serve the particular needs of this natural environment. Towboats or push-boats are typically flat-bottomed, shallow draft vessels designed to tow/push barges and pontoons (“tow”). A pair of knees of ample strength and height engage barges, secured via cables and winches, to maneuver the tow. Historically, the term “tow” or “towboat” comes from the practice of towing a boat from the bank or shore by hand or with the aid of animals before the generation of self-propelled vessels. Today, a tow is generally defined as one or more barges lashed together in a composite unit and pushed by the self-propelled towboat. As the world population grows, so shall the need to economically transport cargo to populations or distribution centers located on navigable inland waters and ocean ports.

Inland marine transportation has become a mature industry in North America, Europe, and South America, and is a rapidly expanding industry. Developing the inland waterways of Asia is also growing as a way to support the rapidly expanding population of this continent.

Earnings in the towboat industry, however, are relatively low due to a variety of alternative forms of transportation and time that it takes to move cargo by barge—despite the relative low-cost to ship cargo by barges. Additionally, the industry is experiencing difficulties recruiting young people who can be trained to be the boat captains of the future. As the towboat designed for this market has not changed appreciably in over 40 years mainly because boats that operate in fresh water are not corroded in the same manner as off-shore boats that operate in salt water. Hence, refurbishing worn out equipment is the norm and new boat building the exception.

Moving people and cargo over the natural and man-made inland waterways of the United States predated European colonization has evolved despite its economic challenges. The Inland Waterway Transportation Industry (IWTI) in the USA today includes more than 6,200 tugboats and towboats, and more than 31,000 barges that offer a combined carrying capacity of over 89 million tons. The industry employs more than 30,000 people, and the fleet moves nearly 800 million tons each year of raw material or finished goods, which equates to 15% of all U.S. freight, along the U.S. inland and coastal waterways.

Barges and Towboat Control Therefor

As previously described, barges are by far the most efficient and cost effective way to move products. Standard barges are 195 feet long, 35 feet wide, and can be used to a 9-foot draft. Typical capacity of a barge is 1500 tons. Newer barges are 290 feet long by 50 feet wide and have double the capacity of earlier barges. As understood in the art, barges are often tied or connected to one another to form a set of barges. It not uncommon to attached barges to form a set of barges upwards with a length of 1200 feet or longer. The barges are typically configured side-by-side and lengthwise such that a set of barges can be arranged 6×6 or other configurations. As shown in FIG. 1, a set of barges or tow can be arranged as 3 across×4 lengthwise, and as shown in FIG. 2, a set of barges can alternatively be arranged as 6 barges across×5 barges lengthwise. As is understood, the number of barges that are typically connected to one another range from 25 to 48, but other numbers are possible and often used for a wide range of reasons.

In general, towboats with large engines are used to move the barges on the rivers. Towboats can have engines that range anywhere from 2,000 horsepower to 10,500 horsepower. Typical means of moving the barges include using one or more towboats at the stern of the connected barges. Although the efficiency of moving cargo using barges is far greater than any other form of transporting goods, many of the towboats that exist within and outside the United states are 50 or more years old. The engines themselves were often locomotive engines. Despite those engines still operating, the efficiencies of those engines are not as high as what newer engines would be. However, because of the expense of newer engines and towboats in general, there is not a sufficient financial justification for replacing the old towboats or their engines absent complete failure, but rather maintenance is the preferred ideology of the fleet. Hence, growth of the fleet is limited simply due to economics and the glut of mature equipment.

Operators of towboats with large engines have become very skilled at handling the tows, but despite having high levels of skills, accidents still occur. Most accidents result in the barges running onto a river bottom, hitting a shoreline, hitting a bridge, or otherwise. These accidents often result from environmental factors, such as the ever-changing river due to high currents, depleted water levels, wind, visibility, ice, mechanical failures, etc. As understood by riverboat operators, depth of waterways can change relatively quickly due to currents produced by precipitation, wind, or a combination thereof. Moreover, rivers are highly dynamic throughout the year based on rainfall, heat, wind, and other environmental factors such that shorelines shift, bottom contours changes, which, in some cases, can be significant. Such dynamic changes on a river can be problematic for riverboat operators as depth of the river can vary and familiar points of reference can vary significantly.

In addition to the environmental factors for safe operation of riverboats and controlling sets of barges, riverboat operator have to content with changing configurations of the barges (e.g., dropping off and picking up). As part of the safe operation, it is understood that stops and turns can be particularly challenging depending on the configuration and size of the set of barges and environmental conditions. Stopping can be problematic, as stopping a typical set of barges from a speed of 8 knots may take 14 minutes, and beginning reversal from a speed of 8 knots can take 18 minutes if environmental conditions are ideal. It should be understood that every tow handles differently, especially as weight and configuration of tows change at ports. Such timing can be particularly problematic as once a set of barges goes off-course, the risk of accidents increases.

Turning a large set of barges is also slow, typically five-degrees per minute (5°/min), given length and configuration of the set of barges. As a result, speeds of moving sets of barges is typically low, especially as the barges pass beneath bridges with mid-river support structures. As shown in FIG. 3, one barge has been propelled over another barge. As shown in FIG. 4, a barge has hit and destroyed a bridge. Accidents can and do occur as the ability to control sets of barges with all the varying weather, river conditions, configuration, and loading conditions can be challenging—even for the best towboat captains. Hence, there is a need to improve control of sets of barges so as to increase maneuverability, safety, and efficiency when moving barges along an inland waterway.

Towboat Working Conditions

Towboat operators face a variety of environmental factors that are problematic for crew endurance and comfort. Such environmental factors result in that crew quarters and helms are located on towboats that include large engines, often two or more (one for each propeller), for propulsion of the tow. The environmental factors include, but are not limited to, fire risks, vibrations, noise, heat, fuel, exhaust fumes, and other factors that affect crew endurance. And, in the event of a breakdown of an engine or a maintenance overhaul, the crew quarters are also out-of-commission. As a result of these environmental factors, crew suffer, even subconsciously, from stresses that over time can cause physical and mental ailments. Moreover, as a result of the environmental factors, and taxing work schedule (typically 12 hour days for 28 consecutive days and 14-28 days off time), the ability to find crew and captains for operating the towboats can be difficult, and attrition rates in the business can be high. As such, there is a need to reduce environmental factors and stress factors on crews.

Logistics

As understood, navigating barges on a river can be a challenge with regard to logistics. At each port, barges and/or cargo may be dropped or picked up. In the event that barge(s) are dropped or added, a set of barges is to be reconfigured to leave one or more barges at the port or pick up one or more barges from the port. Such reconfiguration of the barges can be time consuming and sometimes leads to repositioning of the towboat(s), especially when the towboat is to be disconnected from a barge that is being dropped or connected to a new barge being added to the tow. Logistics of moving barges are also impacted by the requirements of inland waterways. For example, different regions (e.g., states), rivers, etc., have different maximum horsepower limits, which can cause logistic challenges for towboat operators as different horsepower rating towboats are often having to be changed at different locks along a river (e.g., Cairo, Ill.). In the event that a towboat with a large engine does not have a set of barges to bring downriver after traveling up-river, the towboat has to make a “deadhead” run downriver, thereby being expensive and inefficient for a towboat operator and/or shipper of goods. Accordingly, there is a need to improve logistics to add more efficiency to towing barges within an inland waterway.

### SUMMARY OF THE INVENTION

In order for the inland waterway transportation to further evolve, solutions to reduce cost of production of new vessels, improve fuel efficiency when moving tows, improve working conditions for towboat operators, and advance logistics are needed. For example, newer towboats are to reduce fuel burn per barge/mile by moving more barges faster and safer than could be performed otherwise. As previously described, barge safety is needed to avoid accidents that can be catastrophic to property, lives, and the environment. Hence, to move barges faster, more control over the barges or tows is provided in solutions described herein.

One embodiment of a method of controlling a set of barges may include determining whether a rotation command is to result in a rotational force that exceeds a threshold rotational force in response to receiving a rotation command. If not, a first transverse force may be calculated to apply to the set of barges from a first location. A second transverse force may be calculated to apply to the set of barges from a second location aft of the first location. The first and second transverse forces and corresponding locations may define a first rotation point longitudinally along the set of barges. The first and second transverse forces may be applied to the set of barges at the respective first and second locations. Otherwise, if the rotation command is to result in a force that exceeds the threshold rotational force, the first and second transverse forces may be recalculated that, if applied to the set of barges, would cause the rotation point to move to a second rotation point, and the recalculated first and second transverse forces may be applied to the first and second locations. Otherwise, the calculated first and second transverse forces may continue to be applied to the set of barges at their respective first and second locations.

One embodiment of a towboat system for towing barges may include a first towboat module including a first propulsion and steering unit and a first local controller configured to control speed and direction of thrust of the propulsion and steering unit. A second unmanned towboat module may include a second propulsion and steering unit and a second local controller configured to control speed and direction of thrust of the second propulsion and steering unit. A command module may be physically separate from the first and second unmanned towboat modules, and include a command controller that is (i) in communication with the first and second local controllers and (ii) configured to generate and communicate control instructions to the first and second local controllers.

One embodiment of a method of moving a set of barges may include engaging a first unmanned towboat module to the set of barges, where the first unmanned towboat module includes a first propulsion and steering unit and a first local controller. A second unmanned towboat module may be engaged to the set of barges, where the second unmanned towboat module including a second propulsion and steering unit and a second local controller. A command module may be engaged to the set of barges. The command module may be physically independent of the first and second unmanned towboat modules. Control signals may be communicated by the command module to the first and second local controllers to respectively control operation of the first and second propulsion and steering units.

One embodiment of a method for navigating tows along a river may include navigating an first integrated tow system along the river. Geographical locations on the river traversed by the first integrated tow system may be tracked. Depth of the river may be measured at respective geographical locations of the first integrated tow system. The depth of the river may be collected at respective geographical locations. The geographical locations and depth measurements may be collected at the geographical locations of the first integrated tow system to cause a second integrated tow system to navigate the river along the substantially same path as the first integrated tow system.

One embodiment of a method of transporting a set of barges along a set of river sections may include detachably engaging a first unmanned towboat module to the set of barges at a first river section. A second unmanned towboat module may be detachably attached to the set of barges at the first river section. The set of barges may be transported along the first river section.

One embodiment of a method of forming and altering a configuration of a set of barges may include removably attaching multiple barges together to form a set of barges. The set of barges may include a first barge and a second barge that are freely floating on a waterway. A first propulsion system may be removably attached to the first barge. A second propulsion system may be removably attached to the second barge. Positions of the first and second propulsion systems may be automatically controlled to maintain the first and second propulsion systems in substantially fixed positions on the waterway, thereby maintaining the set of barges in a substantially fixed position. At least one barge may be removably attached to the set of barges while automatically controlling the first and second propulsion systems to be in substantially fixed positions, thereby forming an altered set of barges.

### BRIEF DESCRIPTION OF THE DRAWINGS

Illustrative embodiments of the present invention are described in detail below with reference to the attached drawing figures, which are incorporated by reference herein and wherein:

FIG. 1 is a scene of an illustrative set of barges being pushed along a waterway by a towboat;

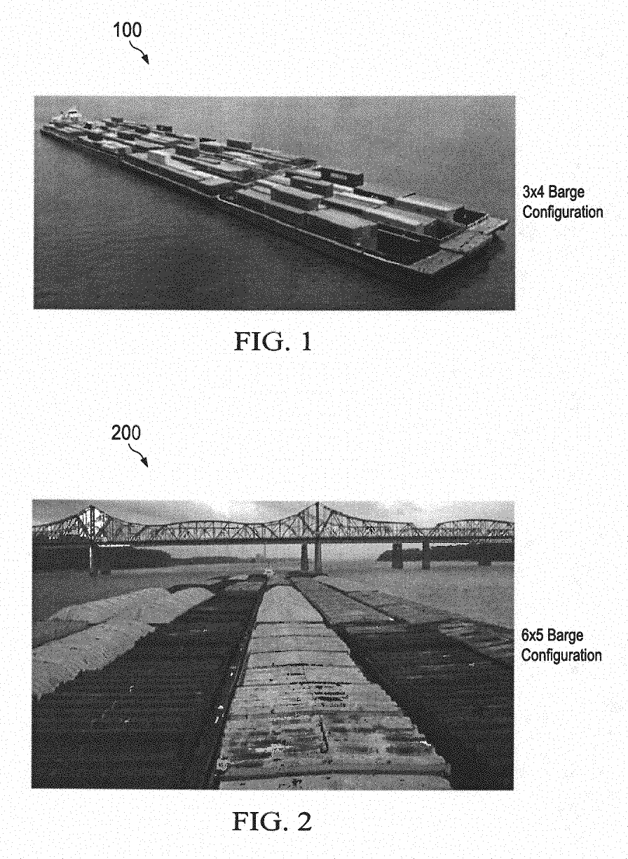

FIG. 2 is a scene of another set of barges traversing underneath a bridge;

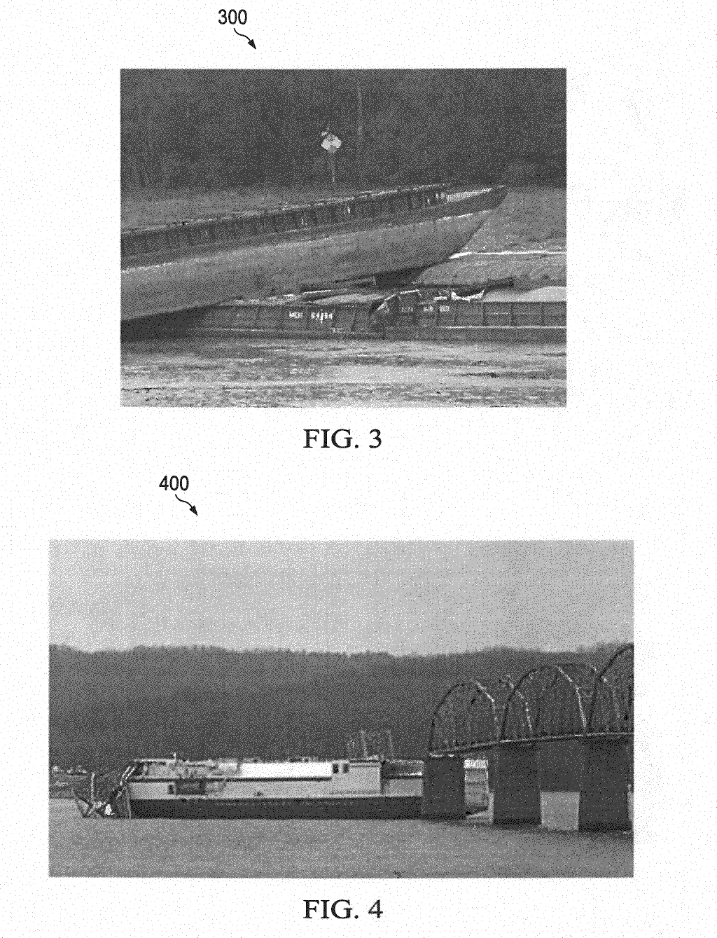

FIG. 3 is a scene of a barge accident with one barge extending over another barge;

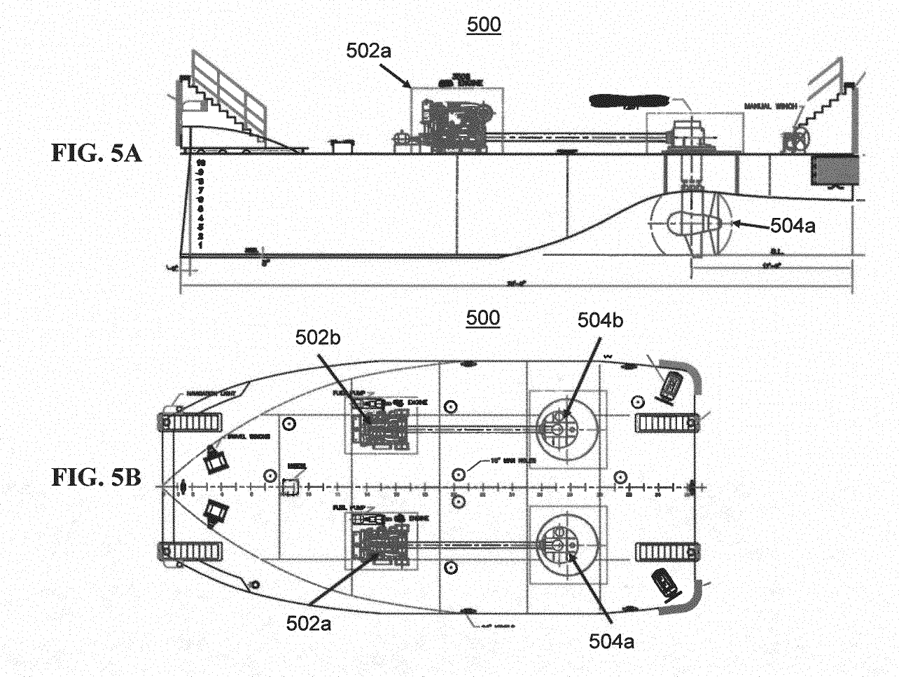

FIG. 4 is a scene of a barge accident in which a barge being pushed by a towboat has hit and destroyed a bridge;

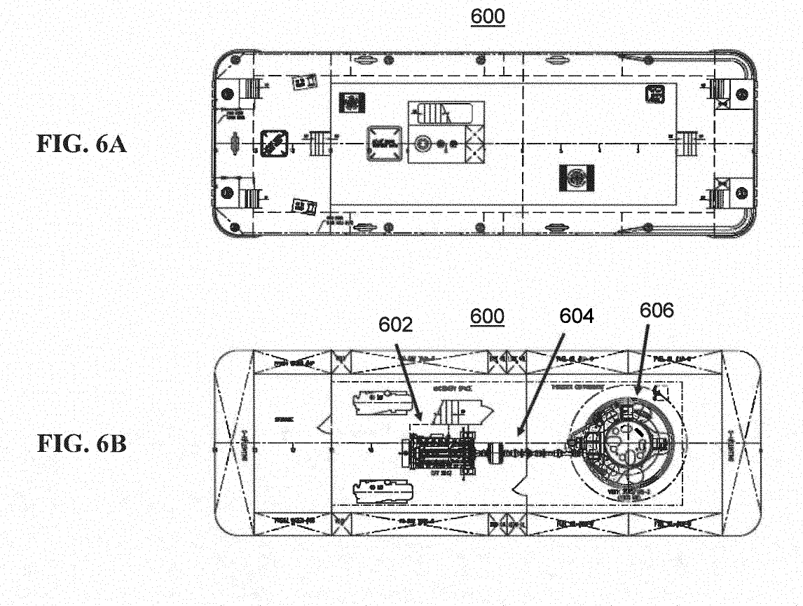

FIGS. 5A and 5B are schematics of an illustrative unmanned towboat module showing a propulsion unit (including multiple engines) with propellers for use in propelling the unmanned towboat module;

FIGS. 6A-6D are schematic diagrams of another illustrative unmanned towboat module;

FIG. 7 is an illustration of illustrative controller system with a user interface that includes a joystick that enables an operator to control one or more unmanned towboat modules;

FIG. 8A is a block diagram of an illustrative tow drive system in which a towboat is configured to communicate with an unmanned towboat module for propelling a tow along a waterway;

FIG. 8B is a block diagram of an illustrative tow drive system in which a command module is configured to communicate with multiple unmanned towboat modules for propelling a tow along a waterway;

FIG. 8C is an illustration of an illustrative tow drive system in which multiple unmanned towboat modules for propelling a tow along a waterway are controlled from a remote, land-based command station;

FIG. 9 is an illustration of an illustrative set of barges that are being pushed by a pair of towboats and showing movement of a rotation point along the set of barges in response to a rotation force command exceeding a rotation command force threshold level;

FIG. 10 is a flow diagram of an illustrative process for controlling a turn of a set of barges by altering a rotation point;

FIG. 11 is a set of modified rotation command curves that may be applied in response to an operator rotation command input that is requested above a threshold rotation command level, such as 80%, to provide a selected rotation command by the operator;

FIGS. 12A-12C, illustrations of illustrative scenes in which tows are being towed by bow and stern (front and back) unmanned towboat modules, and force responses are moving the rotation/pivot point;

FIGS. 13A-13D are illustrations of unmanned towboat modules operating to perform various maneuvers in moving a tow;

FIGS. 14A-14E are illustrations of an illustrative control module or pod that is configured with a controller system optionally inclusive of a joystick, such as that shown in FIG. 7, and operator accommodations;

FIG. 15 is an illustration of a scaled configuration of a set of barges being towed by a pair of unmanned towboat modules along with a control module;

FIG. 16 is an illustration of an illustrative set of barges being moved by a set of unmanned towboat modules including a command module;

FIG. 17 is a flow diagram of an illustrative process for moving a set of barges;

FIG. 18, an illustrative scene of a river on which multiple sets of barges and are being guided by unmanned towboat modules using a river tracking process;

FIG. 19 is an illustration of an illustrative process for navigating a river;

FIG. 20 is an illustration of illustrative map of rivers in the United States;

FIG. 21 is a flow diagram of an illustrative process for transporting a set of barges along a set of river sections or segments;

FIG. 22 is a flow diagram of an illustrative process of forming and altering a configuration of a set of barges, and maintaining fixed position;

FIGS. 23A and 23B are illustrations of illustrative downriver towing of a set of barges respectively without and with a bow unmanned towboat module; and

FIGS. 24A and 24B are illustrations of illustrative upriver towing of a set of barges respectively without and with a bow unmanned towboat module.

### DETAILED DESCRIPTION OF THE INVENTION

The principles described herein include the use of certain nomenclature.

A tow refers to a set of barges, where the set may include one or more barges used to transport goods on a waterway, such as a river.

A towboat refers to a conventional towboat with propulsion and steering equipment used to move a tow.

An unmanned towboat module refers to a boat that provides for propulsion and steering equipment used to move a tow, but is typically configured to be operated remotely, although onboard operator controls may be provided and living quarters are not provided as provided on traditional towboats.

Propulsion and steering equipment refers to equipment on a boat, such as a towboat or unmanned towboat module, that includes one or more engines, propellers, rudders, operator steering equipment, and/or any other equipment used to propel and control direction of the boat.

A propulsion unit includes one or more engines and propellers, but may include any other form of propulsion, such as water jets that provide propulsion or otherwise. A propulsion and steering unit may include a propulsion unit along with steering equipment, such as one or more rudders, propeller(s) that may have blades that may be reoriented to cause directional propulsion or directional propellers, such as Voith, Azimuths, or otherwise.

A propulsion system includes, but is not limited to, an unmanned towboat module. A propulsion system includes a propulsion unit and steering unit, referred to herein as a propulsion and steering unit in some instances.

A control and command module (“command module”) refers to a boat that includes living quarters and provides for navigation equipment, such as a user interface with a joystick, that communicates with unmanned towboat modules to provide commands and receive feedback information for moving a tow. The command module may have propulsion, but generally limited to self-movement as opposed to moving a tow.

A tow drive system refers to a towboat and unmanned towboat module or command module and unmanned towboat modules used to drive a tow.

An integrated tow system refers to any combination of a towboat, unmanned tow module(s), and command module and inclusive of a tow.

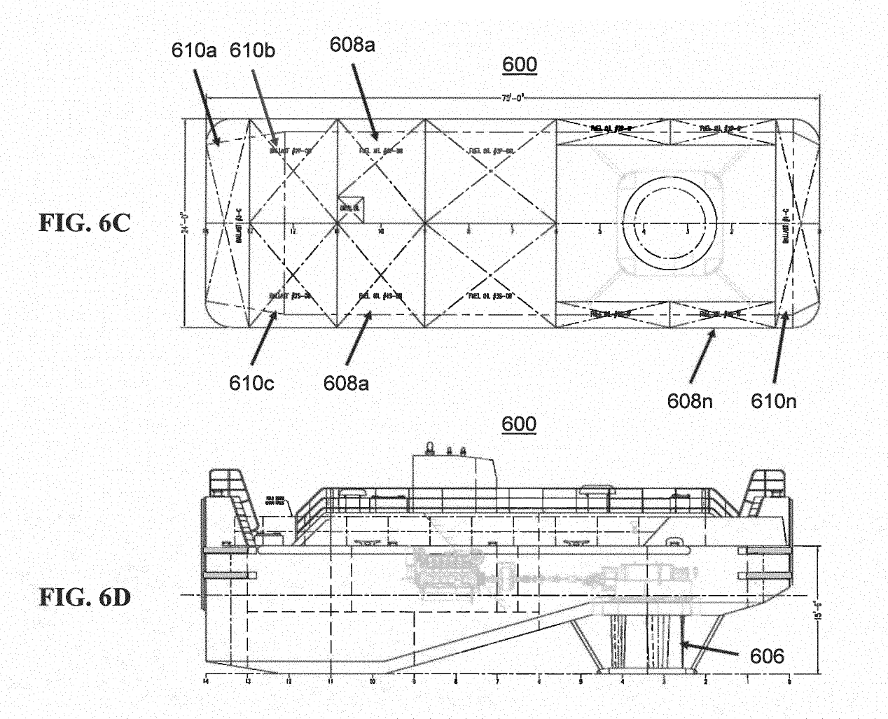

With regard to FIGS. 5A and 5B, schematics of an illustrative unmanned towboat module that improves efficiency and control is shown. As shown in FIG. 5A, a profile view of the unmanned towboat module 500 is shown to include a motor 502a and propeller 504a for use in propulsion for the unmanned towboat module 500. As shown in FIG. 5B, a plan view of the unmanned towboat module 500 includes a pair of motors or engines 502a and 502b and corresponding pair of propellers 504a and 504b. Alternative configurations are possible, as well. The unmanned towboat module 500 is integrated in that it may operate remotely using digital electronics, and provides for increased back-haul capacity, improved steering through turns, creates effective maneuverability, and maximizes fuel economy. Such remote control may be considered to be a drone-type of vehicle configuration. Moreover, the unmanned towboat module 500 increases tonnage capacity, reduces flanking, and improves safety compared to a single towboat at the stern of the tow.

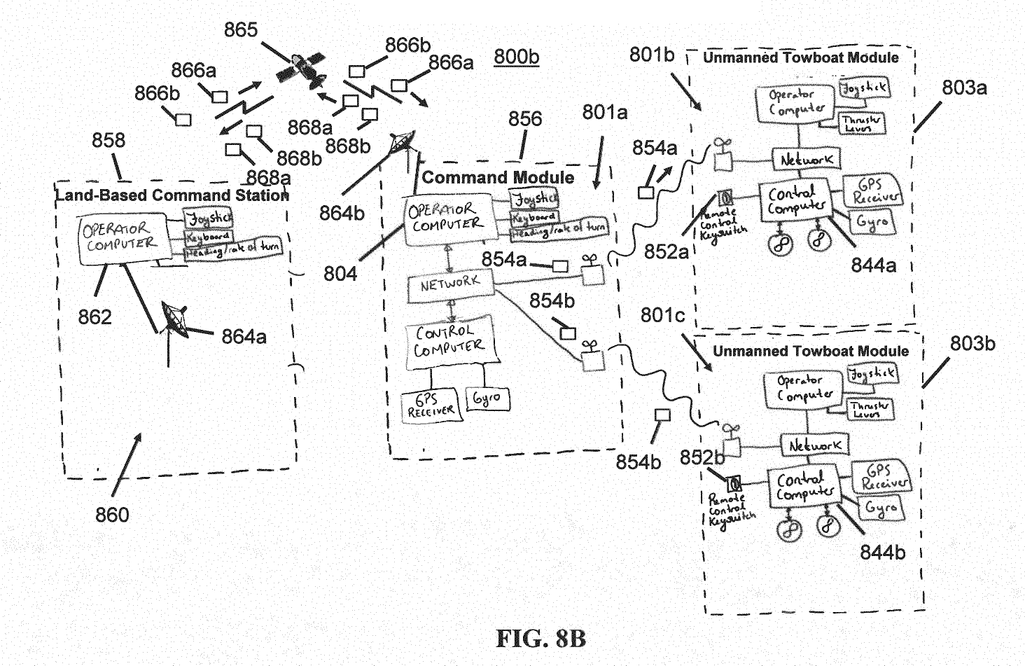

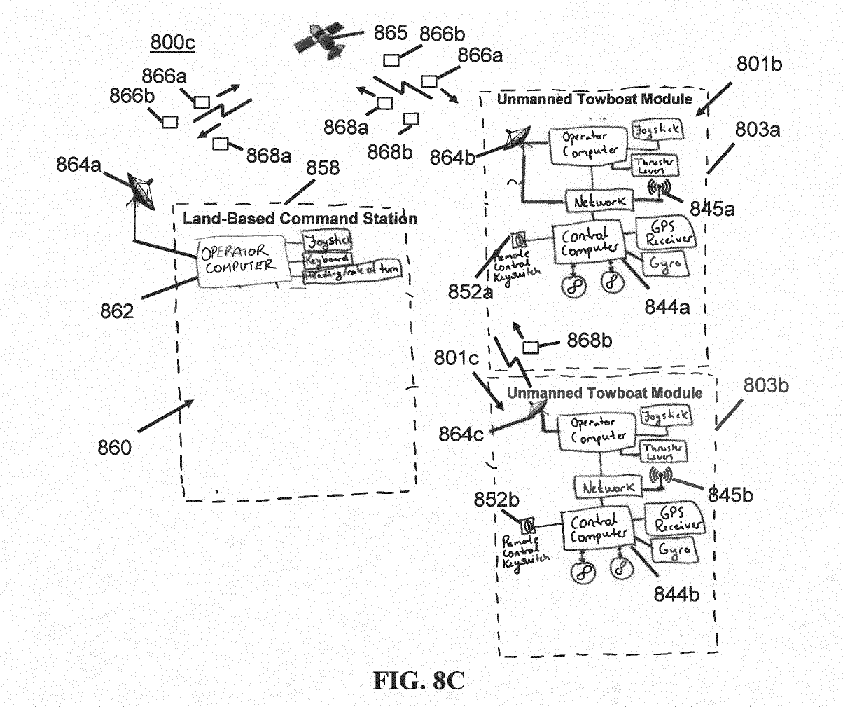

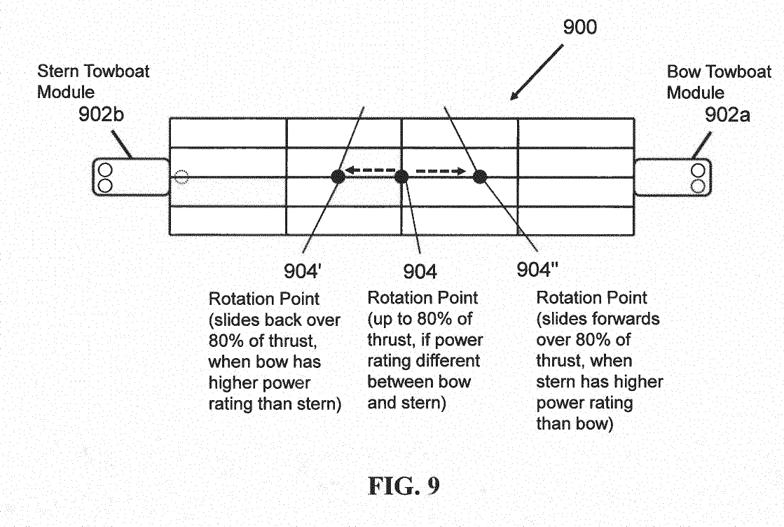

The module 500 is shown to include a 2-drive propulsion system. The two-drive propulsion system provides for steering, and may be operated remotely by a wireless communications system. The propulsion system can be operated locally or remotely. When operated remotely, the module 500 becomes part of a main drive unit. When connected to a set of barges, the barges are into an integrated power tow. This integrated tow may thereafter be controlled as one unit by using an integrated tow controller (see FIG. 8) that achieves steering and propulsion.

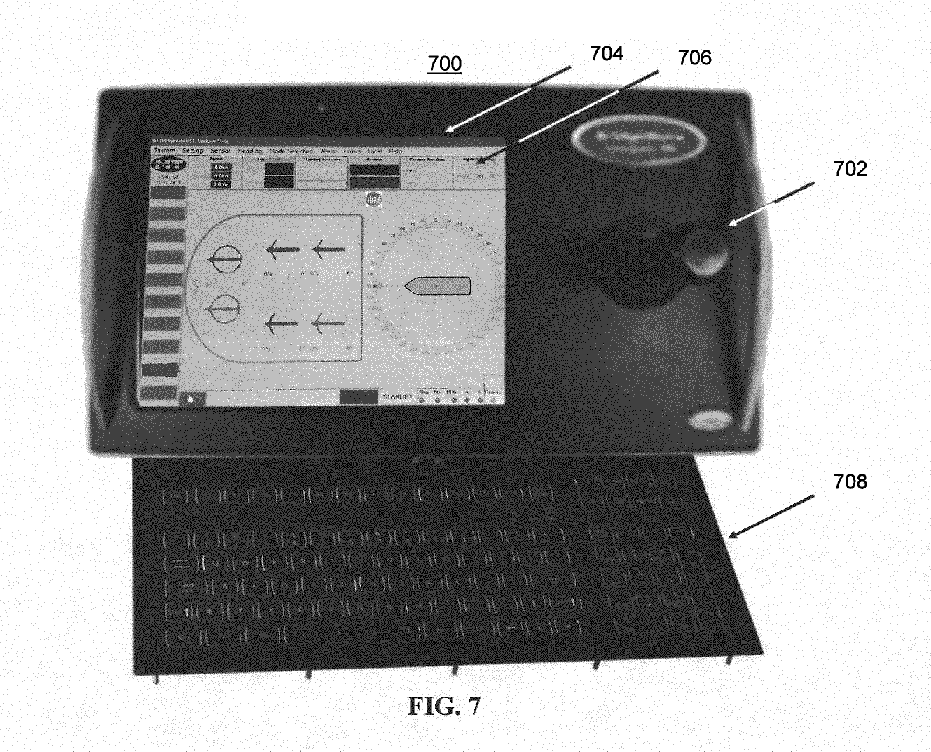

With regard to FIGS. 6A-6D, schematic diagrams of another illustrative unmanned towboat module 600 are shown. With regard to FIG. 6A, a top view of the unmanned towboat module 600 is shown. With regard to FIG. 6B, a bottom view of the unmanned towboat module 600 is shown. In this case, an engine 602 may be attached to a drive system 604 to control rotation of the propeller 606 is shown. In one embodiment, the engine 602 is a marine diesel engine, and the propeller 606 is an advanced propulsion propeller. Marine diesel engines may provide for improved efficiency over conventional engines, and the advanced propulsion propellers 606 may provide for more control than conventional straight shaft propellers, as understood in the art. With regard to FIG. 6C, a bottom view of the unmanned towboat module 600 indicates how a substantial portion of the unmanned towboat module 600 is filled with fuel oil tanks 608a-608n (collectively 608) along with ballast tanks 610a-610n. Alternative configurations are possible.

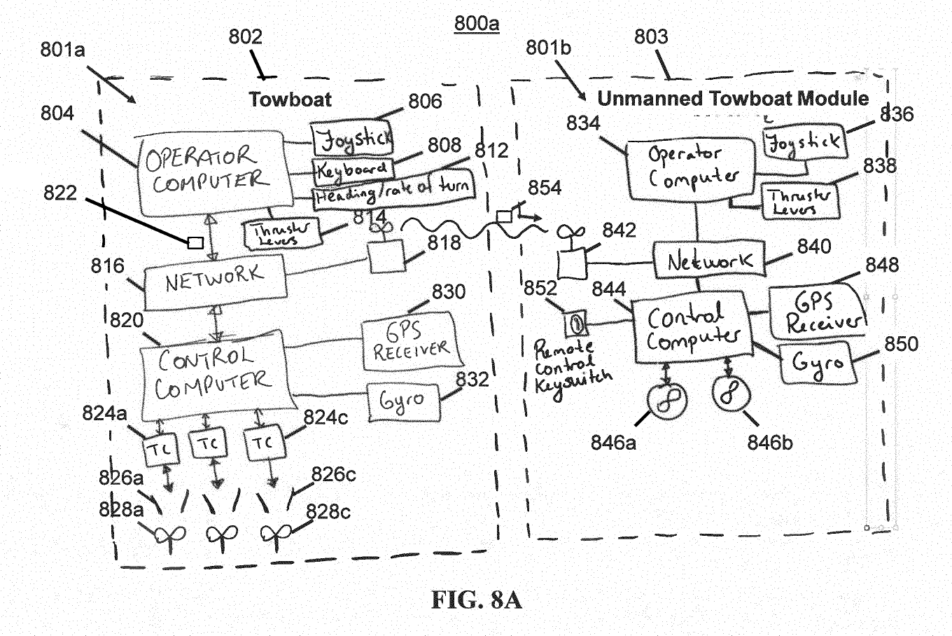

With regard to FIG. 7, an illustration of illustrative controller system 700 with a user interface that includes a joystick 702 that enables an operator to control one or more unmanned towboat modules is shown. The joystick provides the operator with three-axis input for control, including longitudinal, transverse, and rotation. The controller system 700 also includes an electronic display 704 on which a variety of different visuals may be displayed. For example, a graphical representation 706 of the unmanned towboat modules may be displayed with a variety of different sensed indicators displayed thereon. The sensed indicators may include angle, heading, speed, depth, wind speed, distance from objects, such as barges, bridges, and shoreline, and a variety of other information that may be helpful for an operator to visualize what is happening at or near the unmanned towboat module. Alternatively or additionally, a video (not shown) from one or more video cameras captured from one or more locations on the unmanned towboat module may be displayed on the electronic display 704, and/or extra electronic displays, to enable the user to visually inspect scene(s) on a real-time basis, which increases safety and control of the unmanned towboat module(s).

The controller system 700 may further include a keyboard 708 that includes a conventional keyboard and selection buttons. The selection buttons may be configured to enable different configurations based on thruster and engine availability, horsepower/fuel burn optimization, different cameras on the unmanned towboat modules, different graphical representation to be displayed, or more quickly access or display any other device or information so as to provide more efficiency. It should be understood that the controller system 700 may enable a user to operate and control nearly any aspect of the unmanned towboat modules. The controller system 700 may be configured to sense and adjust power of the propulsion units of the unmanned towboat modules on a real-time or near real-time basis at any frequency rate possible and/or needed based on environmental conditions and situations (e.g., tighter turns and higher traffic areas may use higher frequency controls).

The controller system 700 may be onboard or remotely located from the unmanned towboat module, and data may be communicated via wire or wirelessly to the controller system 700 for display thereon and control thereby. Moreover, the user interface may be controlled by a computer system or computing system 810 that may be used to generate control signals that are communicated to an engine to control operation thereof. The control signals, as further described herein, may be defined in such a way that the set of barges to which the unmanned towboat modules are connected may be factored into generating the control signals. For example, a rotation point about which the set of barges or tow rotate may be established by a control law along the set of barges. Adjustment to the rotation point may be made as a result of calculating a rotation command instructed by a user utilizing the joystick 702 (e.g., rotating a grip or tip member of the joystick, rotation settings, remote control commands, or otherwise). Alternatively, if the unmanned towboat modules are operating in an autonomous mode, the control signals may be generated based on autonomous control signals that are automatically generated based on an automated controller navigating a waterway based on a map and/or other real-time or near-real-time data.

A rotation point along the barges may be adjusted forward or aft in response to the computed control signals. As understood in the art, the control signals may be a function of the propulsion capabilities (e.g., horsepower of engine, size of rudders, and so forth) that are propelling the set of barges. Alternatively, the operator may modify the rotation point manually between three or more preset positions using selective buttons representing bow, center, and aft of the tow, for example. Without any bow module connected to a conventional tow, the pivot/rotation point is different on every tow configuration, and cannot be manipulated as may be possible with a bow module and the system 700.

In operation, as understood in the art of towboat operation, the effective manual or keyboard control of two thrusters, two or three propellers, four or five diesel governors, and four to six independent rudders acting against external forces due to current and wind exceeds the ability of the human operator. Therefore, the intuitive joystick 702 may be used, which may include a three-axis joystick by which the desired force, direction, and rotation momentum can be chosen by an operator. Other techniques, such as autopilot along with a heading or rate-of-turn dial, might be used for ease of operation for the operator, as well.

The effect of a rotation command upon the unmanned towboat module control surfaces corresponds to the selection of control parameters by the operator. When underway, the controller system 700 may be configured to use the minimum thruster and rudder angle to accomplish desired course changes. As a result, drag of the towboat related to steering is reduced, which further reduces or eliminates steering corrections that typically result from an operator over-steering and under-steering the towboat.

A computer to which the controller system 700 interfaces may also be configured to select optimum rpm settings for each of the propulsion and steering units of the unmanned towboat module(s) when stopping or accelerating the set of barges into and out of turns, running in a straight line, or with autopilot features. Thus, the joystick and autopilot controls can significantly decrease fuel burn.

In an embodiment, the controller system 700 may calculate thrust of propellers and thrusters along with the angle of thrusters and rudders. The system may be capable of calculating the thrust and angles to cause the unmanned towboat module to perform differently on a river than the system would be configured to operate an offshore support vessel as the waterways are different and present different environmental challenges. Inland river systems and the size of tows being maneuvered provide extremely challenging operating conditions, thereby making the introduction of advanced control systems, such as the controller system 700, described herein represent improvements over conventional operations systems and methods currently possible.

As further described herein, the controller system 700 and computer may aid an operator in bringing the tow upriver in less time and by burning less fuel. The joystick 702 and autopilot with heading and rate-of-turn control aids the operators in maneuvering the tow in a manner, which may reduce (i) turn-around time (i.e., dropping off and adding new barges to the set of barges), and (ii) transit time, and improve fuel burn efficiency. The controller system 700 aids the operators to accomplish maneuvers that were not possible before the unmanned towboat modules because the controller system 700 allows the operator selection of or automatically controls the pivot point on the set of barges being towed.

With regard to FIG. 8A, a block diagram of an illustrative tow drive system 800a in which a control system 801a of a towboat 802 is configured to communicate with a control system 801b of an unmanned towboat module 803 for propelling a tow (not shown) along a waterway is shown. The towboat 802 may include an operator computer 804 by which an operator may interact via a joystick 806, keyboard 808, or other user interface mechanisms (e.g., touchscreen). The joystick 806 may be used to control propulsion and steering of the towboat 802. A heading/rate of turn controller 812 may be configured to enable an operator to set heading and/or rate-of-turn of the towboat 802. The controller 812 may be physical element(s) (e.g., knobs) or soft-elements (e.g., heading knob on touch screen). Thruster levers 814 may also be used to adjust thrusters for performing control of thrusters, such as secondary thrusters for refined movement of the towboat 802.

A communications network 816 may provide for communications of the operator computer 804 via a wireless communications device or radio 818 configured to communicate using a local wireless communications protocol, such as WiFi, to a control system operating on the unmanned towboat module 803 for control thereof. Moreover, the operator computer 804 may communicate via the network 816 to a control computer 820. The control computer 820 may communicate with the control computer 844 via the wireless communications channels to communicate control and/or feedback data between the computers 820 and 844. In an embodiment, navigation control data 822, including heading, thrust, and/or rate-of-turn information, may be communicated to the control computer for computing thrust and rotation data. The actuator command data may be communicated to thruster interface cards or drivers 824a-824c (assuming the towboat 802 has three engines) to control operation of actuators, including rudders 826a-826c and propellers 828a-828c. The drivers 824 may be configured to process commands, such as engine speed (RPM), and translate the commands into voltage or current signals to be applied to the actuator (e.g., engine). Other actuators, including rotating thrusters, azimuth thrusters, fixed pitch propellers, controllable pitch propellers, steering rudders, flanking rudders, tunnel thrusters, or any other actuators that may be available for use in controlling the unmanned towboat module 803 may be controlled. Actuator operational data, such as engine rpm and rudder angle, may be sensed and fed back from the engines, rudders 826a-826c, and/or propellers 828a-828c. The control computer 820 may be configured with a GPS receiver 830 and gyroscope(s) 832 that assist the control computer 820 to maintain headings and fixed positions.

The unmanned towboat module 803 may be configured with a local operator computer 834 that includes a joystick 836 and thruster levers 838 that are the same or similar to those of the towboat 802. The operator computer 834 may provide for an operator to operate the unmanned towboat module 803 locally when not being remotely controlled by the operator computer 804 or other remote control system via a wireless communications device 842, such as a WiFi router or other device, that communications using a local or non-local wireless communications protocol, as understood in the art. The unmanned towboat module 803 may further include a local communications network 840 that supports communications to be performed with the operator computer 804 of the towboat 802 and with a control computer 844.

The control computer 844 may be configured to control propulsion and steering devices. As shown, the unmanned towboat module 803 may include propulsion devices 846a-846b (collectively 846) that are advanced propulsion propellers that are configured to provide both propulsion and steering capabilities, as understood in the art. The control computer 844 may also be configured with a GPS receiver 848 and gyro(s) 850 that are used to assist in navigation and stationary positioning by generating positioning and rate-of-change information. In an embodiment, a remote control key switch 852 may be available to an operator to cause the control computer 844 to be controlled by a remote computing system, such as the operator computer 804, by control signals 854 that are sent from the network radio 818 to the radio 842. It should be understood that telemetry data (not shown) may be collected by the control computer 844 and communicated back to the operator computer 804 from radio 842 to radio 818. In the event that the remote control key switch is set to remote control (as opposed to local control), then commands from the operator computer 834 are ignored so that conflicting commands are not issued to the control computer 844. In an embodiment, the operator computer 804 may also be configured with an override mode that enables the operator computer 804 to override commands of the operator computer 834 on the unmanned towboat module 803 in the event of a malfunction or malfeasance by an operator on the unmanned towboat module 803,

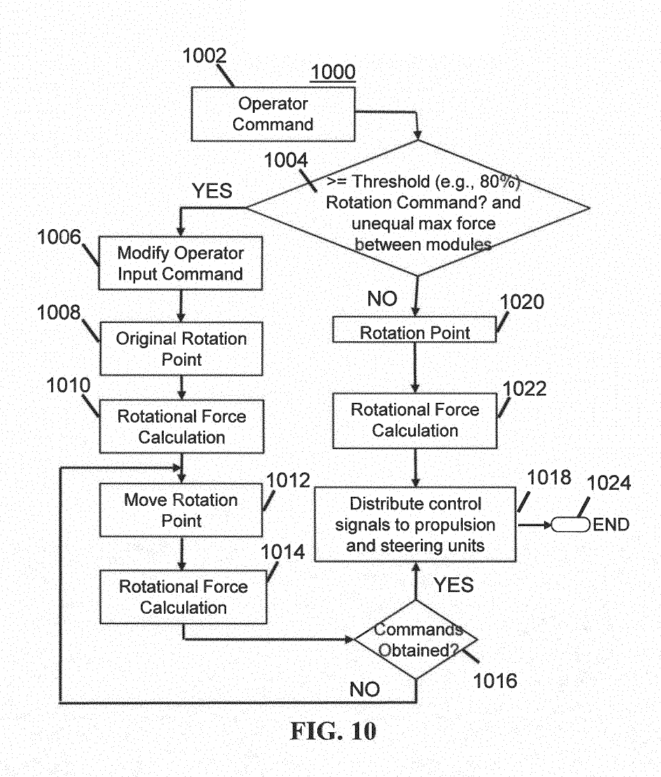

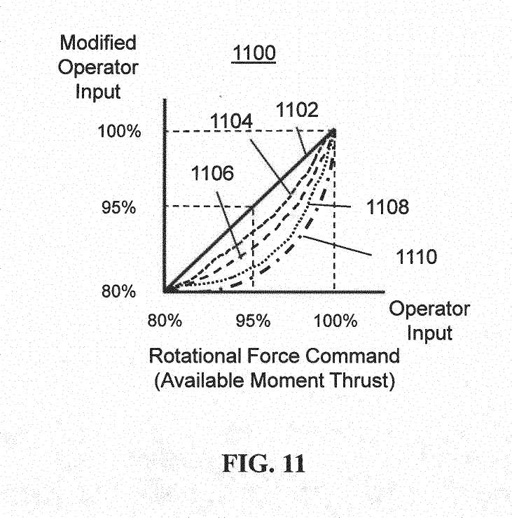

In operation, and more specifically, the operator computer 804 may be configured to calculate mathematical equations, control algorithms, and drive signals for controlling rudders 826, and propellers 828, but not limiting to conventional propulsion. In an embodiment, the operator computer 804 may be configured to monitor rotation forces to determine when the operator is requesting a rotation force that is too high to maintain a 1:1 rotation force between the towboat 802 and unmanned towboat module 803 that would cause the unmanned towboat module 803, often positioned at the bow of the tow, not to be able to adequately support a rotation request due to not having sufficient power, as further described with regard to FIGS. 9 and 10.

With regard to FIG. 8B, a block diagram of an illustrative tow drive system 800b in which the control system 801a of the command module 856 may be configured to (i) generate command and control signals and (ii) communicate with a first control system 801b of a first unmanned towboat module 803a and a second control system 801c of a second unmanned towboat module 803b (collectively 803) for propelling a tow (not shown) along a waterway is shown. In this case, an operator of the command module 856 may control operation of the command module 856 along with operation of each of the unmanned towboat modules 803a and 803b from the operator computer 804. Operational feedback data from each of the actuators (e.g., engines, rudders, etc.) on the modules 803 may be used by each of the respective control systems 801a-801c to control operation of the actuators to track operations of each of the control systems 801a-801c and movement/position of the tow drive system 800a and modules 856 and 803 thereof. Telemetry data (not shown) may be generated by control computers 844a and 844b of the respective control systems 801b and 801c of the unmanned towboat modules 803, and communicated back to the operator computer 804 for use in monitoring and generating control signals to properly move or maintain stationary position of the integrated tow drive system 800b. The unmanned towboat modules 803 may each include remote control key switches 852a and 852b so that both unmanned towboat modules 803 may be controlled by the operator computer 804. Control signals 854a and 854b may be communicated to respective control computers 844a and 844b.

In an embodiment, a land-based command station 858 including a various hardware 860 that may be used to remotely track and manage operations of the tow drive system 800b. The land-based command station 858 may include an operator computer 862 that may be used to track and manage operations of the tow drive system 800b using a data repository (not shown). The operator computer 862 may further be configured to display a variety of different data that may be generated by the operator computer 862 or received from the command module 856 and/or unmanned towboat modules 803a or 803b. In operation, the operator computer 862 may generate and communicate data with the operator computer 804 and may receive and communicate data via a ground-based satellite dish 864a to a vessel-based satellite dish 864b via a satellite 865.

The data may be (i) instruction data 866a and 866b that may be specifically directed to each of the respective unmanned towboat modules 803a and 803b, and (ii) telemetry data 868a and 868b that may be inclusive of measured position, motion, force, and/or any other information that may be collected and/or generated by the control systems 801 of the unmanned towboat modules 803. The instruction data 866a and 866b may include query or polling requests, GPS destination data, routing data, notification data, and/or any other data that the command module 856 or unmanned towboat modules 803 may utilize prior to, during, or after navigation on a waterway. The operator computer 862 of the control system 801a may thereafter communicate the data via local wireless networks (e.g., WiFi networks) to the control systems 801b and 801c of the unmanned towboat modules 803a and 803b, as previously described with regard to FIG. 8A.

With regard to FIG. 8C, an illustration of an illustrative tow drive system 800c in which multiple unmanned towboat modules 803a and 803b for propelling a tow along a waterway are controlled from a remote, land-based command station 858 is shown. The land-based command station 858 may include an operator computer 862 that operates in the same or similar manner as the operator computer 804 on the towboat 802 of FIG. 8A or command module 856 of FIG. 8B. It should be understood that the software processes that compute control signals on the towboat 802, command module 856, and command station 858 may vary due to sensing or not sensing direction and rotation on vessels on which the operator computer may be positioned. That is, the land-based command station 858 does not include GPS and gyro sensors, so the operator computer 862 is to rely on such signals measured on the unmanned towboat modules 803a and 803b. In this case, a satellite dish 864a either positioned at the command station 858 or otherwise (e.g., conventional satellite service provider) may be used to communicate control signals 866a and 866b generated by the operator computer for controlling heading and rotation of the unmanned tow boat modules 803a and 803b.

As shown, each of the unmanned towboat modules 803a and 803b may include vessel-based satellite dishes 864b and 864c for communicating data to and from the satellite dish 864a of the land-based command station 858. However, it should be understood that only one of the unmanned towboat modules 803a or 803b may include a vessel-based satellite dish 864b or 864c, and data may be communicated between the control systems 801b and 801c on the unmanned towboat modules 803a and 803b using a local wireless communications system (e.g., WiFi or otherwise) that may be formed by wireless communications devices 845a and 845b. The wireless communications between the control systems 801b and 801c may operate in the same or similar manner as described with regard to FIG. 8A for control signals 854. It should be understood that the wireless communications may include other non-control signal data, as well. It should be understood that other configurations for communicating data between the land-based command station 858 and unmanned towboat modules 803 may be utilized. By limiting the tow drive system 800c to unmanned towboat modules 803, an on-shore operator may be able to fully control operation of the system 800c and associated tow. In an embodiment, a combination of the land-based command station 858 and unmanned towboat modules 803 may be configured to be semi-autonomous (e.g., user provides initial command and/or guidance instructions) or autonomous (e.g., system 800c performs navigation based on automatically determined instructions by the operator computer 862 of the station 858).

Telemetry data 868a and 868b (collectively 868), which may include heading and rotation data of each of the respective unmanned towboat modules 803, may be communicated from the control computers 844 via ground and vessel-based satellite dishes 864a and 864b to the operator computer 862 for processing thereby. It should be understood that the telemetry data may include many other data values (e.g., location, status, temperature, etc.) from the unmanned towboat modules 803, as understood in the art.

As a result of the configuration of the land-based command station 858 and unmanned towboat modules 803, the ability for the tow drive system 800c to operate in manual, semi-autonomous, or fully autonomous modes may be possible. As such, the configuration of the tow drive system 800c allows for moving tows with minimal or no personnel. In one embodiment, the operator computer 862 may be configured to be operated by a user to provide control and navigation information to the operator computer 862 form communication to the control computers 844a and 844b to control operation of the unmanned towboat modules 803. Such a configuration may be considered a drone operation, whereby constant command and control of the unmanned towboat modules 803 is handled by an operator at the operator computer 862. In another embodiment, the operator may provide a destination location or geographic coordinates to the tow drive system 800c, and the destination location may be communicated to the control computers 844a and 844b. The control computers 844a and 844b may be configured to receive, process, and automatically program themselves to navigate to the destination location. In yet another embodiment, the tow drive system 800a may be fully automated (i.e., using automated guidance and autopilot functions) after an operator instructs the operator computer 862 with destination location of the tow. The automation may use various tracking processes, as further described herein, as part of or in addition to automated control operations.

With regard to FIG. 9, an illustration of an illustrative set of barges 900, in this case 4×4 barges, that are being pushed by a pair of unmanned towboat modules 902a and 902b (collectively 902) and showing movement of a rotation point 904 along the set of barges in response to exceeding a rotation force threshold level is shown. The rotation force threshold level may be determined by an equation, and may be linear while in a 1:1 ratio. In an embodiment, when the unmanned towboat modules 902 are moving the set of barges 900 in a straight line, the rotation point 904 may be centered along the set of barges 900. The rotation point 904 may be maintained as the rotation forces are able to maintain a 1:1 ratio by the bow and stern unmanned towboat modules 902. In other words, the rotation point 904 may be used when a rotation command does not exceed 80% of available rotation force or thrust, thereby maintaining optimized control, fuel usage, and directional balance of the tow.

However, as an operator applies a rotation command by using a controller, and in an embodiment, by rotating a joystick to command a rotation of the set of barges 900 by using the power of the unmanned towboat modules 902. As the rotation force exceeds available rotation force (e.g., about 80%) than can be applied by the bow unmanned towboat module 902a, then the controller (or computing system in communication therewith) may calculate different control signals that cause the rotation point 904 to shift towards the stern of the set of barges 900 to a new rotation point 904′. By shifting the rotation point 904 toward the stern of the set of barges, the bow unmanned towboat module 902a may have more rotation power or influence than the stern unmanned towboat module 902b, thereby providing an operator with more control of the set of barges 900.

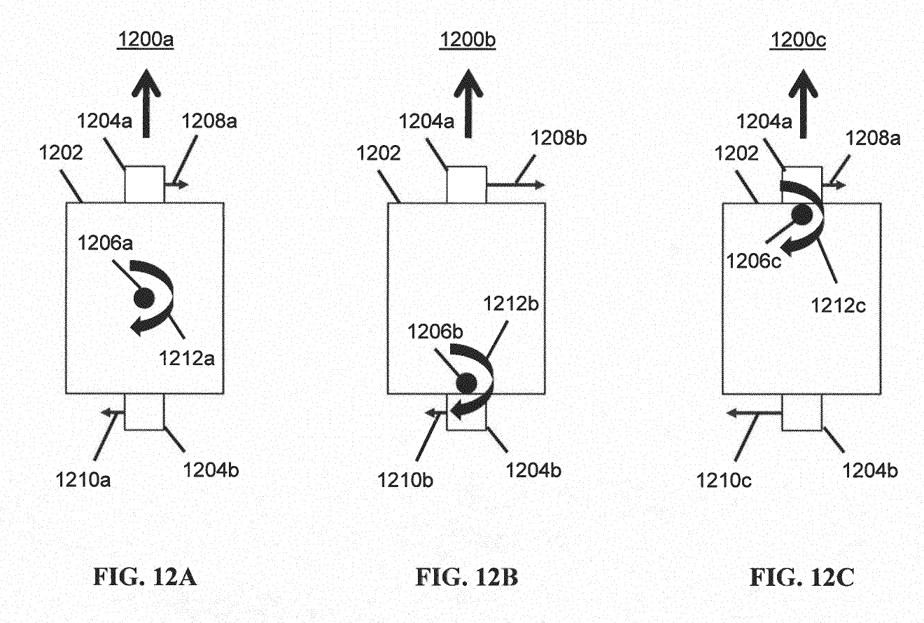

Conversely, as the rotation command exceeds available rotation force than can be applied by the stern unmanned towboat module 902b, then the controller (or computing system in communication therewith) may calculate different control signals that cause the rotation point 904 to shift towards the bow of the set of barges 900 to a new rotation point 904″. By shifting the rotation point 904 toward the bow of the set of barges, the stern unmanned towboat module 902b may have more rotation power or influence than the bow unmanned towboat module 902a, thereby providing an operator with more control of the set of barges 900. Having more control over the set of barges 900 improves safety, and allows for increased speed for transporting the set of barges 900, as further described herein. As further described herein, the rotation points may be selected by an operator or automatically set, and a force curve by which the integrated tow system will follow when a rotation command exceeds a rotation force threshold level may have a default, be selected automatically based on various factors (e.g., turn angle, water current, wind, tow dimensions, available turning power, etc.), or by an operator. The various selectable force curves (see FIG. 11) may provide different turning profiles, and may be selectable by an operator to match a preference of the operator or assessed situation (e.g., gradual turn, sharp turn, etc.).

With regard to FIG. 10, a flow diagram of an illustrative process 1000 for controlling a turn of a set of barges by altering a rotation point is shown. The process 1000 may start at step 1002, where an operator command may be input from an operator or autopilot. The operator command may be entered by an operator using a joystick or other controller device, as understood in the art. At step 1004, a determination is made whether the operator command includes rotation command that is at or above a threshold level, such as about 80%, and unequal maximum force exists between bow and stern unmanned towboat modules. It has been determined that when a rotation command is at or above about 80% that the ability for a bow unmanned towboat module with lower transverse force than a stern towboat, that the ability to control the set of barges being towed is reduced or lost. In such a situation, a 1:1 rotation ratio cannot be maintained as the bow module limits the stern module. As previously described with regard to FIG. 9, the opposite is true when the stern unmanned towboat module limits the bow unmanned towboat module. It should be understood that the threshold level may vary depending on a configuration of the towboats (e.g., engine power of bow and stern towboat and/or unmanned towboat modules), configuration of set of barges (e.g., 4×6, 3×3, etc.), and environmental conditions. Such a situation results in a loss of fuel efficiency, loss in time efficiency (e.g., boats have to be slowed down), increase risk in liability or damage to the set of barges and structures (e.g., bridges or other vessels), and potential for catastrophic injury or loss of human life.

In response to determining that the rotation command from the operator is above the threshold level at step 1004, the system may modify the operator input command at step 1006. In modifying the operator input command, the command may be modified based on a rotational force command curve, as provided in FIG. 11. At step 1008, a determination of the original rotation point (e.g., rotation point 904 of FIG. 9) may be made. The determination may simply be accessing a memory location at which the original rotation point is positioned. In an embodiment, the original rotation point may be determined to be centrally located between propeller(s) of the bow and stern towboats and/or unmanned towboat modules (i.e., the tow drive system). In another embodiment, the original rotation point may be determined to be centrally (e.g., longitudinally) located along the set of barges. Alternative locations of the original rotation point may be set based on a variety of configurations. However, for efficiency purposes, a central location of the rotation point of the set of barges allows for a 1:1 power or thrust of the bow and stern towboat and/or unmanned towboat modules to be made. As an example, if an propulsion power of the bow unmanned towboat module is 2400 HP and an propulsion power of the stern unmanned towboat module is 9000 HP, then propulsion forces applied to rudders by both unmanned towboat modules operate at a 1:1 rotation force ratio when making gradual turns.

In the event of tighter turns having to be made in response to an operator requesting a higher rotation force, a rotational force calculation may be made at steps 1010 and 1014. The rotational force calculation may be made for the entire tow, and distributed commands to each engine that controls rotation of each propeller, thruster, and/or rudders. In the case of multiple engines being on a single towboat or unmanned towboat module, rotational force calculations may be distributed to engines to apply to propellers or thrusters and rudders to cause the commanded rotation force. All engines, propellers, and thrusters may be part of the rotational force calculations even though these are not used for generation of rotational forces. The rotational force calculations may then set these engines, propellers, and/or thrusters to generate zero rotational force on the tow, but may instead provide longitudinal forces for compensation of losses in longitudinal or transverse forces due to generation of rotational forces.

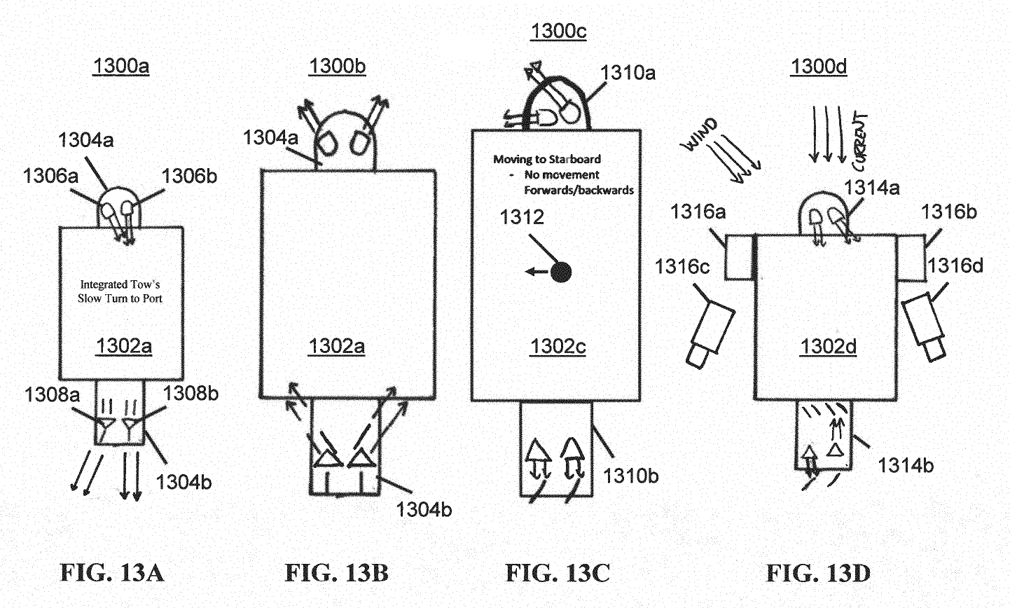

The process 1000 continues at step 1012, where the rotation point is moved towards the bow or aft of the original rotation point. By moving the rotation point toward the bow or forwards of the center of the set of barges, more transverse force at the stern of the vessel compared to the bow, as shown by transverse forces 1210c and 1208c (see FIGS. 12A-12C), may result in more rotational force generated in the aft compared with a rotational point in the center of the tow. By moving the rotation point toward the bow or forwards of the center of the set of barges, more transverse force at the bow of the vessel compared to the stern, as shown by transverse force 1210b and 1208b, may result in more rotational force generated in the bow compared with a rotational point in the center of the tow. Such forces are analogous to applying forces to a door with a hinge, where the door moves more easily the farther a force is applied to the door away from the hinge.

At step 1014, a rotational force calculation may be made based on the new rotation point determined at step 1012. The rotational force calculation made at steps 1010 and 1012 may be made based on a rotation force command that may be established prior to performing the force calculation at step 1010, as shown in FIG. 11. The rotational force calculations may be translated into propulsion and rudder commands to the bow and stern unmanned towboat modules (or other propulsion systems) to cause each to apply respective transverse forces to create a rotational moment on the tow. The process 1000 may continue at step 1016, where a determination may be made as to whether commands (e.g., control commands) have been obtained. If so, then the process continues at step 1018 for distribution of the control signals with the control commands to propulsion and steering units. Otherwise, if the commands have not been obtained, then the process returns to step 1012.

In response to a determination be made that the rotation command is less than a threshold level at step 1004, then the process may continue at step 1020, where a rotation point is determined. The rotation point in this case will be maintained as the original rotation point (e.g., centrally located rotation point 904 of FIG. 9). At step 1022, a force calculation may be made. In the event that the operator command received at step 1002 is straight (i.e., no rotation), then the rotational force calculation made at step 1022 will be longitudinal (i.e., straight). However, if the operator command made at step 1002 requests rotation of the integrated tow system, then the rotational force calculation made a step 1022 will include transverse forces to be made by the bow/stern unmanned towboat modules or towboat(s). At step 1016, commands to the unmanned towboat modules may be made based on the rotational force calculations made at any of steps 1010, 1014, or 1022. The commands will be the same or different to each of the unmanned towboat modules, as described herein. The process 1000 ends at step 1024 until another operator command is made at step 1002.

With regard to FIG. 11, a set of rotational force command curves that may be applied to thrusters being applied to tow a set of barges for rotation command requests over a threshold rotational force command level, such as 80%, are shown. As shown, a first curve 1102 is linear between a rotational force command of 80% and 100%. This curve (or an extension thereof between 0% and 80%) is to be used if the rotational force command request is below the threshold rotational force value that is set to 80%, and represents a 1:1 rotational thrust command to bow and stern unmanned towboat modules. It should be understood that alternative rotational threshold force levels may be utilized. As shown, there are multiple other rotational force curves 1104, 1106, 1108, and 1110. These rotational force curves may be preset and selectable by an operator depending upon his or her desired trajectory or style. The rotational force commands provide for rotational forces to be applied to each of the bow and stern thrusters to make a turn that has a rotation force requirement above a threshold rotational force, such as 80%. The different rotational force curves may be set based on aggressiveness that the operator desires in making turns. As shown, the rotational force curve 1110 is less aggressive than the rotational force curve 1104 in the 80% to 95% range. In an embodiment, and operator may be provided with the ability to set his or her desired rotational force curve, thereby providing flexibility in the controller system.

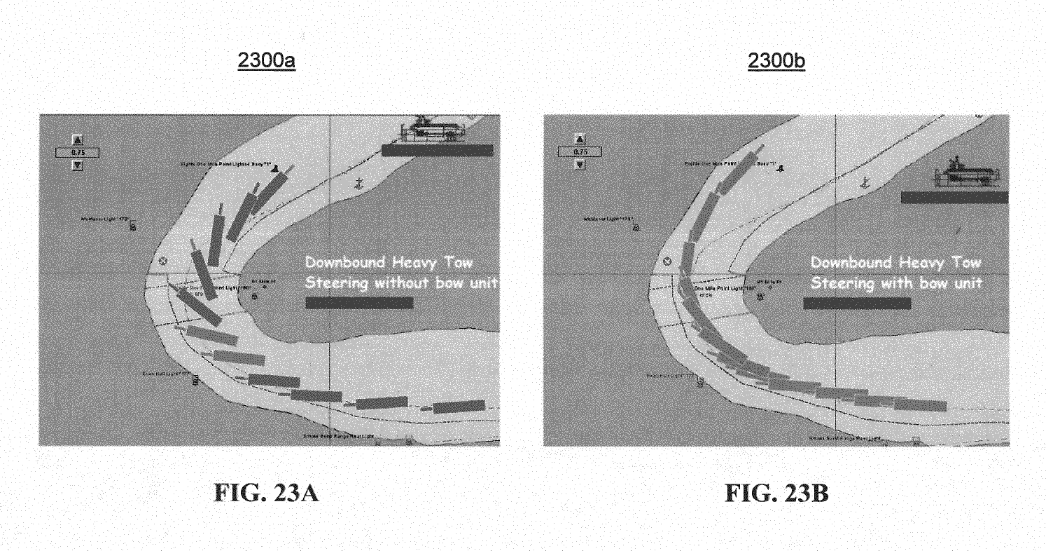

With regard to FIGS. 23A and 23B, illustrations of illustrative downriver towing of a set of barges respectively without and with a bow unmanned towboat module are shown. As provided in FIG. 23A, the lack of a bow module or other rotational propulsion results in the stern of the set of barges to swing wide across the apex of the turn. As shown in FIG. 23B, by providing for a bow module or other rotational propulsion and shifting a rotation point and/or applying a non-linear rotational force as shown in FIG. 11, the set of barges is able to make a less sweeping stern, thereby providing for a higher degree of safety as riverbed depth becomes less of a factor as a deeper part of the river may be traversed by the set of barges and unmanned towboat modules.

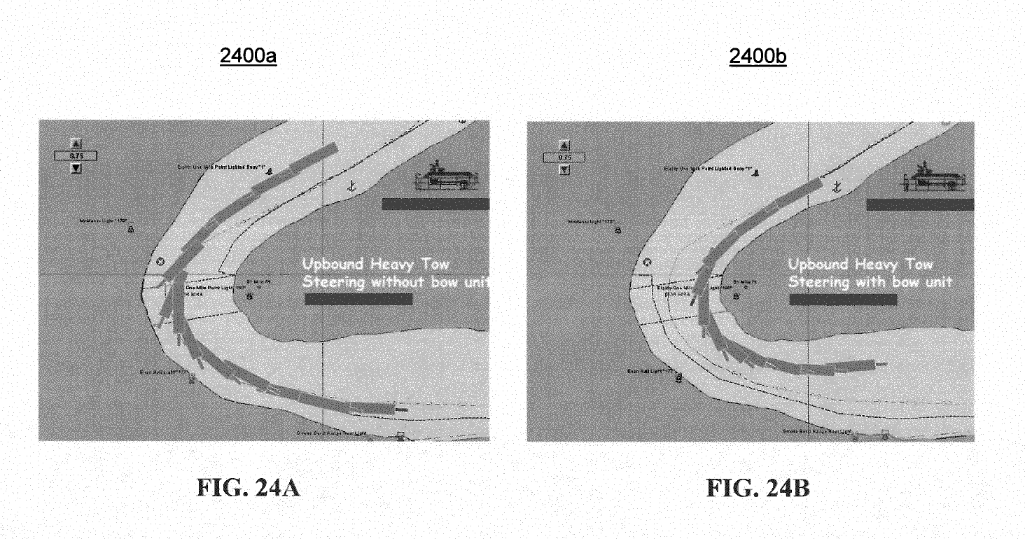

With regard to FIGS. 24A and 24B, illustrations of illustrative downriver towing of a set of barges respectively without and with a bow unmanned towboat module are shown. As provided in FIG. 24A, the lack of a bow module or other rotational propulsion results in the stern of the set of barges to swing wide across a turn. As shown in FIG. 24B, by providing for a bow module or other rotational propulsion and shifting a rotation point and/or applying a non-linear rotational force as shown in FIG. 11, the set of barges is able to make a tight turn toward the inside apex (or elsewhere) of the turn, thereby providing for a higher degree of safety as riverbed depth becomes less of a factor as a deeper part of the river may be traversed by the set of barges and unmanned towboat modules.

With regard to FIGS. 12A-12C, illustrations of illustrative scenes 1200a-1200c in which sets of barges in a tow 1202 being towed by bow and stern (front and back) unmanned towboat modules 1204a and 1204b are shown. The bow unmanned towboat module 1204a may have a lower thrust/force than the stern unmanned towboat module 1204b, may be the opposite. In alternative configurations, the set of barges 1202 may be towed by more than one unmanned towboat module located anywhere around or within the set of barges 1202 with similar rotational force applications and responses, as further described herein. Rotation points 1206a-1206c (collectively 1206) are shown to be in different locations as a result of the transverse forces applied by the unmanned towboat modules 1204a and 1204b, and such rotation points 1206 may be determined by a control computing system depending on the rotational force commanded and rotational forces available to be applied. Alternative algorithms for moving the rotation points 1206 may be utilized, as well.

With regard to FIG. 12A, transverse forces 1208a and 1210a are respectively applied by the front and back unmanned towboat modules 1204a and 1204b to generate rotation force 1212b to the set of barges. As shown, the rotation point 1206a is shown to be centrally located relative to the set of barges 1202. The transverse forces 1208a and 1210a are equal in force to create a 1:1 rotational moment 1212a at the rotation point 1206a, which provides for efficient use of fuel for rotation.

With regard to FIG. 12B, transverse forces 1208b and 1210a are respectively applied by the front and back unmanned towboat modules 1204a and 1204b to generate rotation force 1212b to the set of barges. As shown, the rotation point 1206b is shown to be located at the back of the set of barges 1202. The transverse force 1208b is much higher than the transverse force 1210b, which causes a rotational moment 1212b at the rotation point 1206b and the bow to slide sideways.

With regard to FIG. 12C, transverse forces 1208c and 1210c are respectively applied by the front and back unmanned towboat modules 1204a and 1204b to generate rotation force 1212c to the set of barges 1202. As shown, the rotation point 1206c is shown to be located at the front of the set of barges 1202. The transverse force 1210c is much higher than the transverse force 1208c, which causes a rotational force 1212c at the rotation point 1206c and the stern to slide sideways. The amount of transverse force applied by each of the unmanned towboat modules 1204a and 1204b are controllable based on a force command curve, such as one or more of the curves shown in FIG. 11. The rotational forces shown in FIGS. 12B and 12C and movement of the rotational points 1206b and 1206c may result in response to the controller system determining that an operator is requesting a rotational force greater than a threshold rotational force, such as about 80%.

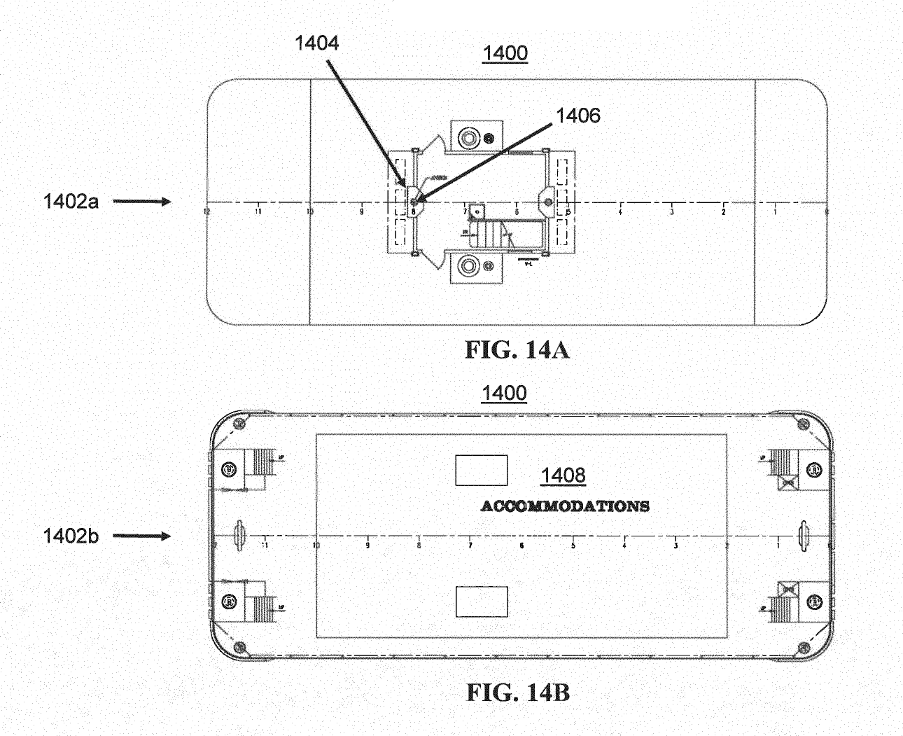

With regard to FIG. 13A, an illustration of an illustrative integrated tow system 1300a inclusive of a tow 1302a and a set of unmanned towboat modules 1304a and 1304b (collectively 1304) each having a pair of propulsion and steering systems 1306a/1306b and 1308a/1308b operating to perform a slow turn counterclockwise is shown. Usage of the set of unmanned towboat modules or units 1304 provides higher steering efficiency than operations that use a conventional stern towboat configuration. The bow unit 1304a combined with a stern unit 1304b is able to provide higher steering forces at smaller thruster and rudder angles; therefore, the speed loss and fuel burn of the tow 1302a due to steering is less. The remaining net thrust of the bow unit 1304a and the stern unit 1304b is greater, and the resultant skidding or slipping that is characteristic of towboats pushing a tow around a turn is dramatically reduced. Thus, the integrated tow system 1300a is able to negotiate turns more quickly and create opportunities to avoid being held up for southbound, downriver traffic. As a result, a decrease in transit time and a reduction of fuel burned for the northbound leg may be realized.

With regard to FIG. 13B, an illustration of an integrated tow system 1300b, moving in reverse direction of the integrated tow system 1300a, is shown to be stopping the set of barges or tow 1302a by reversing thrust by the unmanned towboat modules 1304. As understood in the art, reversing the direction of propeller rotation stops a towboat. More specifically, the integrated tow 1300b is stopped by reversing direction of the thrusters and by diverting each outboard propeller race outwards of each of the unmanned tow boat modules 1304, one port and the other starboard, through independent operation of the towboat's main rudders or flanking rudders (rudders placed in front of the propellers).

With regard to FIG. 13C, an illustration of an integrated tow 1300c moving sideways is shown. The integrated tow 1300c may be moved sideways by maneuvering the integrated tow 1300c into a desired position is not only practical, but may facilitate building or breaking up a set of barges or tow 1302c or may make possible safer traffic separation in restricted channels. In moving the set of barges 1302a sideways, the bow and stern modules 1310a and 1310b be controlled to apply rotational forces in the same direction (e.g., both applying a rotation force to starboard) such that rather than rotating around a pivot or rotation point 1312, the rotation point 1312 is slid or pushed in the opposite direction of the direction of the rotational forces (e.g., rotational forces applied starboard=rotation point sliding toward port).

With regard to FIG. 13D, an illustration of an integrated tow 1300d used to “park” a tow 1302d by applying forces that counter wind and current forces being applied to the integrated tow 1300d is shown. The integrated tow system 1300d includes an unmanned bow towboat module 1314a and unmanned stern towboat module 1314b. Rather than using the unmanned stern towboat module 1314b, a towboat that is in communication with the unmanned bow towboat module 1314a may be utilized.

In an embodiment, creating effective maneuvering, including maintaining a stationary position, by using a variety of transverse forces is shown. Strictly speaking, the word “maneuvering” includes all other conditions of operation other than running ahead or astern at a constant speed and on a straight course. When the tow is holding in the current below a turn awaiting southbound traffic, or when building a tow (e.g., adding barges to an existing tow), the integrated tow system 1300d may maintain heading and position in the stream or current of a waterway (e.g., river) and wind. Maintaining position may be a function of the operator operating a joystick of a controller system (see FIG. 7, for example) or is accomplished automatically by the selection of an automated “river parking” mode. As is known in the art, fixedly positioning a set of barges eliminates the historical operation of pushing the tow (e.g., set of barges) into a bank of a river, which is currently standard operating procedure. By not pushing the tow onto a riverbank, wear and possible damage to the barges is reduced or eliminated. Moreover, private property issues, environmental issues (e.g., bank erosion), disturb rocks, and other problems result from parking the tow onto a riverbank. Another application of this river parking function is to hold the set of barges in position, midstream, while assist towboats work both sides of the set of barges to build the set of barges, which allows reduced transit times to and from a barge fleet.

As shown, additional barges 1316a-1316d (collectively 1316) may be added to the tow 1302d while the modules 1314 maintain the tow 1302d in a substantially fixed position on the waterway. The barges 1316 are being added to the left and right sides of the tow 1302d. If the tow 1302d is to be lengthened, then one or both of the unmanned towboat modules 1314 may be temporarily separated from tow 1302d, other barges connected to the end(s) of the tow 1302d, and the unmanned towboat module(s) 1314 connected to the newly added barge(s). In an alternative embodiment, the new barge(s) may be inserted between other barges (i.e., in a mid-portion of the tow 1302d), thereby both ends of the tow 1302d being controlled at all times by the modules 1314. Removal of barges may be conducted with a similar, but reverse, process.

Backhaul capacity may be increased using an integrated tow system, as well. The effective thrust generated by the bow unit and towboat (or bow and stern unmanned towboat modules 1314a and 1314b) is roughly equal to that which is produced by a single towboat having the same horsepower of an integrated tow. Thus, an integrated tow is able to increase the back haul load above that of a smaller towboat. Equally interesting is efficiency gain of an integrated tow, which was discovered to be approximately 167% of a single towboat having the same horsepower of the integrated tow.

Operation and Control of the Towboat Units

With further regard to FIGS. 7 and 9-13, when underway, the controller system 700 may be configured to use a minimum thruster and rudder angle to accomplish desired course changes. By minimizing thruster and rudder angle, drag that is related to steering is reduced, and steering corrections that are typically the result of operator over-steering and under-steering may be avoided. Rudder control is generally determined by an operator's estimation of the amount of rudder that is required to start or stop a turn, and is based upon what the operator sees on a rate-of-turn indicator (rate gyro).

The controller system 700 may also be configured to select optimum speed (rpm) settings for each engine or thruster of the towboat and/or unmanned towboat module being used to move a set of barges when stopping, running, or accelerating the set of barges into and out of turns. Thus, the controller system 700 can significantly decrease fuel burn. Typically, operators operate by pushing a throttle to the rack (limit) or putting the towboat in reverse. In the case of the controller system 700, a computing unit calculates the thrust of propellers and thrusters, and the angle of thrusters and rudders with a minimum thrust and angle optimization applied. Hence, controller system 700 is capable of calculating a required thrust and angles as the towboat and/or unmanned towboat modules to optimally move a tow or set of barges to be propelled upriver or downriver. The joystick 702 of the controller system 700 aids the operators in bringing the tow upriver in less time and by burning less fuel. Fuel burn is a function of drag that results from how often the throttles are put to the rack and how often the rudders are moved off of the centerline position.

Reversing the direction of propeller rotation stops a towboat. The integrated tow may be stopped by reversing direction of the propeller rotation on the towboat and by diverting each outboard propeller race outwards, one port and the other starboard. Operators now stop the tow by reversing thrusters and working the flanking rudders to maintain heading against propeller torque and river current. Maneuvering the tow into the desired position, such as a barge fleeting area, is not only practical but may facilitate building or breaking up the tow or may make possible safer traffic separation in restricted channels. Conventionally, tows are maneuvered by steering and propulsion located at the extreme end of the tow. Consequently, the tow must be pushed into or tied off to moored barges or willow trees on the bank. Conventionally, tows need to be parked far away from the barge fleeting area, resulting in barges needing to be moved separately from the tow to the barge fleeting area. Holding position in the river, near the barge fleeting area, can drastically reduce time spent delivering and receiving barges from the fleet.

Flanking operations are operation techniques conducted during southbound trips, which use the river current as a factor to push the entire tow around the bends of the river with controlled speed. Flanking operations start up-river, where the speed of the entire tow is matched with the river current prior to entering the apex of the turn. Around the bend of the river, the current helps rotate the entire tow around the apex. Once the wanted turn has been achieved, the operator starts increasing the speed of the tow, and pushes away from the river bend. Numbers of flanking operations during a single trip depends on a number of factors, such as size of tow, towboat power, tow weight, river conditions, operator judgement, etc. By utilizing an integrated tow system with a bow module and a stern module compared to conventional towboat at the stern, flanking operations can be drastically reduced and duration of the flanking maneuver reduced. As such, an integrated tow system can instead increase number of barges in the tow, while still only perform the same number of flanking operations as the conventional towboat positioned with fewer barges and without a bow unit, thereby resulting in more barges being carried down-river with a reduction in transit time.

Decoupled Control and Command Module from Unmanned Towboat Modules

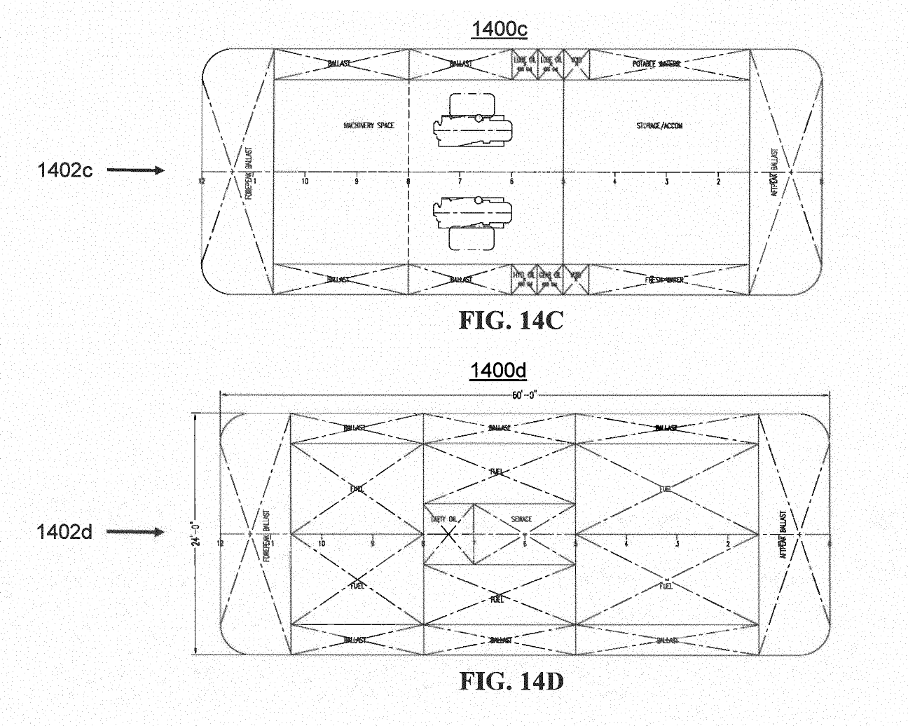

With regard to FIGS. 14A-14E, illustrations of an illustrative control and command module or pod 1400 with decks or levels 1402a-1402d (collectively 1402) that is configured with a controller system 1404, navigation equipment inclusive of a joystick 1406, such as that shown in FIG. 7, and operator accommodations 1408 are shown. As shown in FIG. 14A, the top level 1402a of the command module 1400 is shown to include the controller system 1404 that may be used to control operations the unmanned towboat module(s), such as those shown in FIGS. 6A-6D, that include engines and propulsion equipment (e.g., thrusters, propellers, etc.). As shown in FIG. 14B, the level 1402b may include operator accommodations 1406 are shown to include a substantial portion of the floor, and may be divided in any number of ways to provide rooms, as understood in the art. As shown in FIG. 14C, the level 1402c may include storage and equipment areas. Ballasts may also be located on this level 1402c. As shown in FIG. 14D, the lowest level 1402d one or more fuel tanks that may be used for powering a generator that powers equipment onboard the command module 1400, as further described hereinbelow, along with ballasts. In an embodiment, the command module 1400 may be 24′×70′ or any other dimensions that are capable of providing adequate accommodations for the operators and enable the operators to have sufficient visibility for navigating a set of barges or other tow, as understood in the art. It should be understood that the dimensions, number of decks, and other physical parameters shown in the figures are illustrative and that a wide variety of other parameters may be utilized that provide for the same or similar functionality may be utilized.

The command module 1400 does not include an engine or propulsion equipment that is used to tow one or more barges, thereby eliminating environmental conditions that are problematic for operators (e.g., crew and captain) of a towboat. The command module 1400 may include propulsion for moving the command module 1400, such as an propulsion and steering, to enable the command module 1400 to be moved independent of unmanned towboat modules.

With regard to FIG. 14E, an illustration of a side view of the command module 1400 is shown to include the various levels 1402a-1402d. In addition, the command module 1400 may include various communications, navigation, and lighting equipment 1410 installed on top of a roof 1412 of the top level 1402a so as to communicate with a variety of different communications systems, including unmanned towboat modules being remotely controlled by the command module 1400.

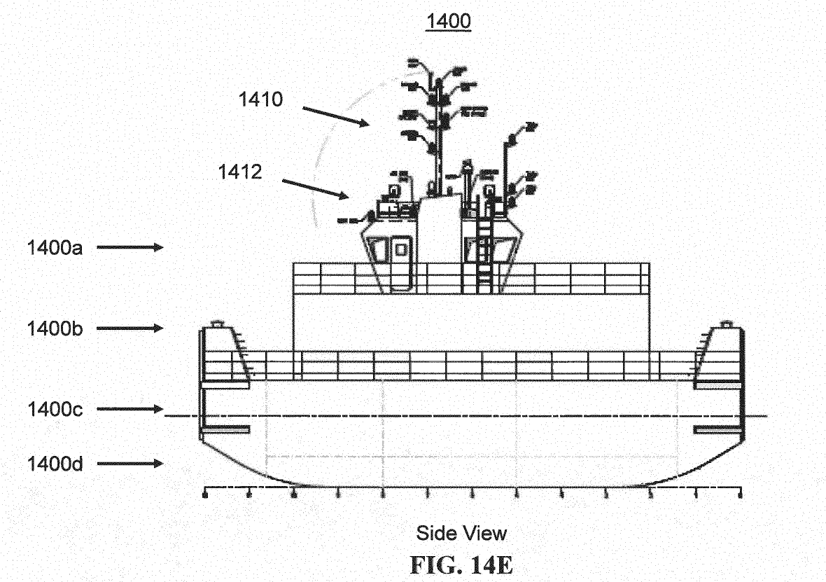

With regard to FIG. 15, an illustration of a scaled configuration of a set of barges 1500 being towed by a pair of unmanned towboat modules 1502a and 1502b (collectively 1502) along with a command and command module 1504 is shown. In this case, the barges are 195′×35′ and there are 5 barges×3 barges being towed by the unmanned towboat modules 1502. The command module 1504 is also attached to the barges 1500, but does not operate as a towboat or unmanned towboat module, but rather operates to provide accommodations for the operators and remote control for the unmanned towboat modules 1502.

One embodiment for a tow drive system for towing barges may include a first unmanned towboat module including first propulsion and steering and a first local controller configured to control speed and direction of thrust of the first propulsion and steering. A second unmanned towboat module may include second propulsion and steering and a second local controller configured to control speed and direction of thrust of the second propulsion and steering. A command module may be separate from the first and second unmanned towboat modules, and include a command controller or controller system that is (i) in communication with the first and second local controllers and (ii) configured to generate and communicate control instructions to the first and second local controllers.

In an embodiment, the command module may include living quarters for operators of the integrated tow system. As shown, the command module is configured to float. The command module may include an engine capable of moving the control module, but not operable in performing towing of barges. Depending on power requirement of the tow, unmanned towboat modules may be added in sufficient number to meet the power requirement of the tow for safe transit along the river(s). This allows operators to properly scale tow size with adequate power. Power requirement of the tow can be adjusted based upon tow configuration, river conditions, and other commercial and environmental conditions. The unmanned towboat modules may have different power/maneuverability ratings or propulsion types.

As an example, the first propulsion unit may have a power rating higher than the second propulsion unit. A third unmanned towboat module may include third propulsion unit and a third local controller configured to control speed and direction of thrust of the third propulsion unit. The third propulsion unit may have a same power rating as the first propulsion unit. The first and second unmanned towboat modules and the command module may be configured to be releasably engaged to one another to enable the command module to be moved by the first and second unmanned towboat modules.

In an embodiment, the unmanned towboat module propulsion units may include marine diesel engines. The command controller may be configured to be wirelessly in communication with the local controllers of the different unmanned towboat modules. In an embodiment, a power rating of a replacement unmanned towboat module may have a lower maximum power rating than a maximum power rating of the an existing unmanned towboat module and be configured to receive control signals from the command controller.

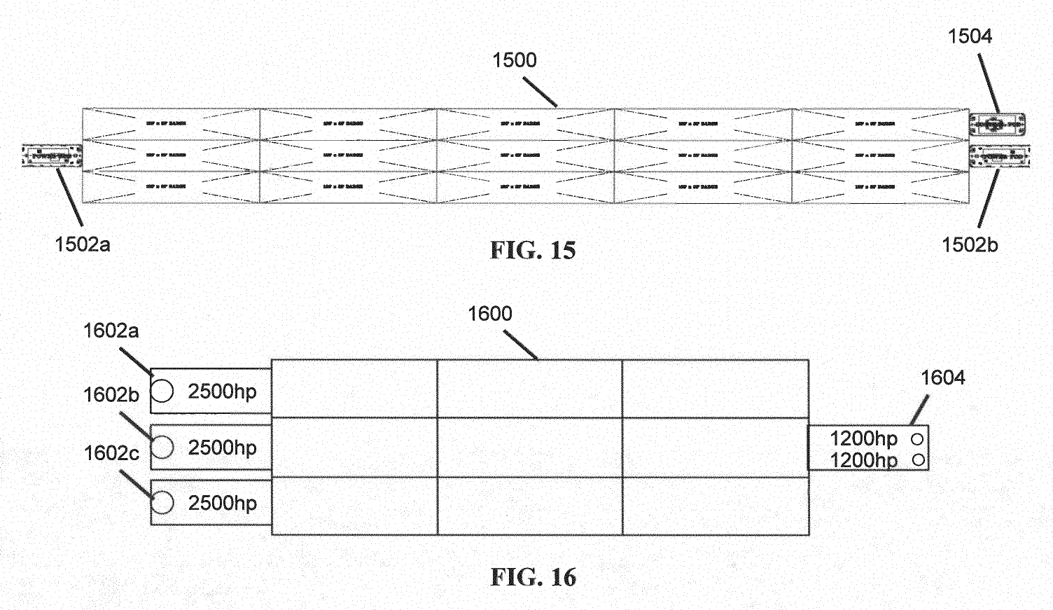

With regard to FIG. 16, an illustration of an illustrative set of barges 1600 being moved by a set of unmanned towboat modules 1602a-1602c and 1604 is shown. In this case, rather than having a control module, command and controls are performed remotely from the set of barges, such as from a command system on shore with a remote pilot (e.g., human pilot) so as to operate as a “drone integrated tow system.” In an embodiment, the command and control may be performed remotely via a satellite link, for example. As shown, rather than using a large engine, such as 9000 hp, which is often used, multiple unmanned towboat modules with smaller engines, in this case 2500 hp, may be utilized so as to create an effective 7500 hp propulsion system. It should be understood that a control module may be used in an embodiment rather than having three unmanned towboat modules 1602a-1602c, two unmanned towboat modules and one command module may be utilized. It should be further understood that alternative sized propulsion units may be utilized, and that the unmanned towboat modules may be swapped for unmanned towboat module(s) with alternative sized propulsion units and steering to accommodate the number of barges, stretch of river, regulations, and other factors. Ultimately, as understood in the art, the selection of propulsion power ratings of unmanned towboat modules may be based on physical requirements established by a tow and environmental conditions (e.g., river current, weather conditions, etc.) of which the unmanned towboat modules are to be connected to propel a tow along a river. It should further be understood that unmanned towboat modules may be added around the set of barges, or inside the set of barges, and is not exclusive to be connected to the set of barges at the bow and at the stern.

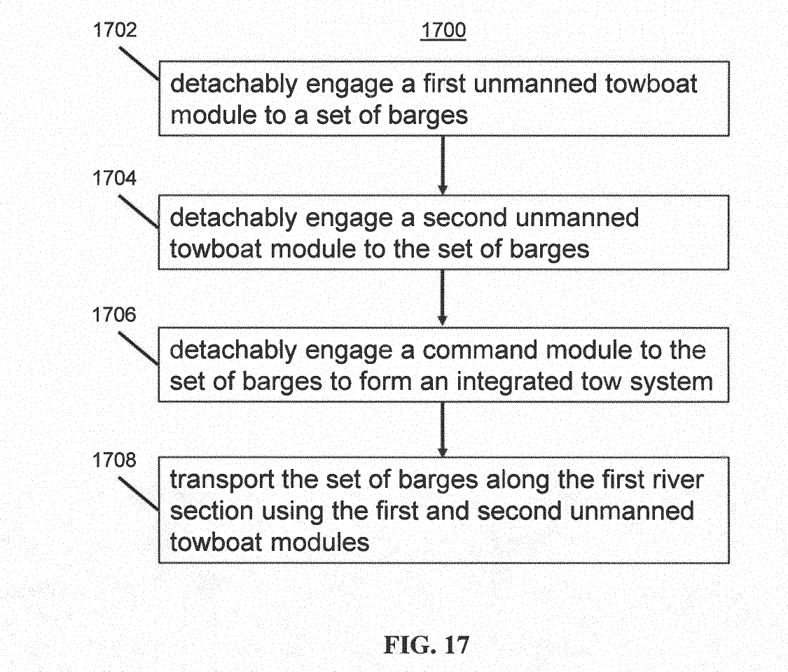

With regard to FIG. 17, a flow diagram of an illustrative process 1700 for moving a set of barges is shown. The process 1700 may start at step 1702, where a first unmanned towboat module may be detachably engaged to the set of barges. The first unmanned towboat module may include (i) first propulsion and steering and (ii) a first local controller. At step 1704, a second unmanned towboat module may be detachably engaged to the set of barges, where the second unmanned towboat module may include (i) second propulsion and steering and (ii) a second local controller. A command module may be detachably engaged to the set of barges to form an integrated tow system at step 1706. The command module may be physically independent of the first and second unmanned towboat modules. At step 1708, the set of barges may be transported along the first river section using the first and second unmanned towboat modules. In an embodiment, control signals may be communicated from the command module to the first and second local controllers to respectively control operation of the first and second propulsion and steering units.

The process of controlling a unmanned towboat module and associated equipment are to receive control signals from the command module and distribute the commands locally on the unmanned towboat module to the local equipment, and further distribute information and data from the local equipment back to the command module for processing. In an embodiment, the communication is performed wireless, but is not limited to wireless technology. The command module may interact with several unmanned towboat modules, and takes each of the unmanned towboat modules connected to the set of barges into consideration real time for processing and decision making. Further information from the unmanned towboat modules and command module may be distributed via satellite to onshore fleet management facilities for support and monitoring.

The process may further be configured to communicate first control signals from the command controller to the first local controller and second control signals from the command controller to the second local controller. In an embodiment, the communication is performed wirelessly.

In one embodiment, a third unmanned towboat module may be engaged to the set of barges. The third unmanned towboat module may include a third propulsion unit and a third local controller. Third control signals may be communicated from the command controller to the third local controller to control operations of the third propulsion unit. The first and third unmanned towboat modules may be engaged to a stern of the set of barges, the second unmanned towboat module may be engaged to a bow of the set of barges. The first and third control signals may include limiting maximum power signals to the first and third propulsion units to be the same.

In an embodiment, a determination of an amount of rotation force being commanded by the operator or automated processes to be applied on the first and second modules connected to a set of barges are limited 1:1 rotation between the first and second modules while under a threshold, such as 80%, of the maximum allowed rotational command force. It is understood that to achieve 1:1 rotation of the set of barges, the rotation point is generally centered between the length of set of barges in the tow. Operator or automated rotation force command requests are subjected to linear or non-linear adjustments prior to sending commands to the first and second modules for any commands between the threshold and maximum (e.g., between about 80% to about 100%) allowed rotation force. The linear and non-linear adjustments to the command from the operator or automated processes gives rise to various aggressive or slack commands in the region (e.g., 80% to 100%) of maximum allowed rotation force. As a result, the use of a non-linear adjustment may reduce or increase large changes in rudder or angle of thruster changes for the described rotation command region, thereby improving river tracking, timing, and fuel efficiency. In an embodiment, an amount of rotation requested by a rotation command of an operator may be determined to be greater than about 80% of available rotational force available by the first and second propulsion and steering units, and altering control signals to the first and second local controllers in response to determining that the rotation requested by a rotation command is greater than 80% of available rotational force available by the first and second propulsion and steering units.

The command module may be floating while engaged. The control module may be driven to the set of barges, and while the first and second unmanned towboat modules are being used to move the set of barges, an engine on the command module may not be used to propel the command module. The first propulsion unit may be caused to operate at a higher power level than a maximum power rating of the second propulsion unit. In an alternative embodiment, the first propulsion unit may be operated at a lower power level than the maximum power rating of the second propulsion unit, but there may be multiple unmanned towboat modules at a stern of the set of barges such that the propulsion units combine to have a higher power level than the second propulsion unit.

River Tracking

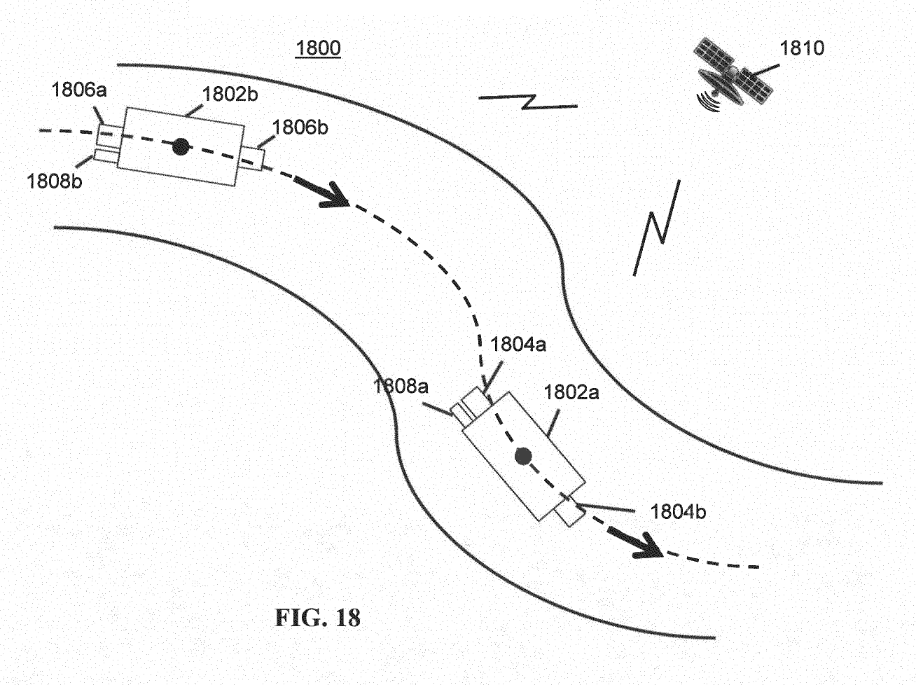

With regard to FIG. 18, an illustrative scene of a river 1800 on which multiple sets of barges 1802a and 1802b are being guided by unmanned towboat modules 1804a/1804b and 1806a/1806b is shown. Also shown underway are control modules 1808a and 1808b in which operators are housed. As previously described, as rivers are well known to constantly change due to precipitation and other factors, the ability to navigate a river has historically been performed by experienced captains. However, rather than using historical or other knowledge, to better avoid running onto sandbars or other shallow portions of a river, especially given the nature of changes of rivers and riverbeds, one embodiment provides for tracking river depth by collecting depth measurements from unmanned towboat modules that are traveling along a river. Each unmanned towboat module used to tow a set of barges may collect corresponding depth measurement and geo-coordinate or graphical location (e.g., global positioning system (GPS)) data for the integrated tow system.

The data may be communicated via a communications network, such as via a satellite 1810 over a satellite network, to a networked server (not shown) for storage. The networked server may thereafter communicate the collected data to other integrated tow system so that those integrated tow system may follow the same or similar path or otherwise use the data for navigational knowledge purposes. It should be understood that the process may be performed in conjunction with other boats, and not limited to being used by integrated tow systems. In an embodiment, the integrated tow systems may have automatic tracking functionality that automatically follows the geo-coordinates within the limits of available data collected from other integrated tow systems that previously traversed a river section.

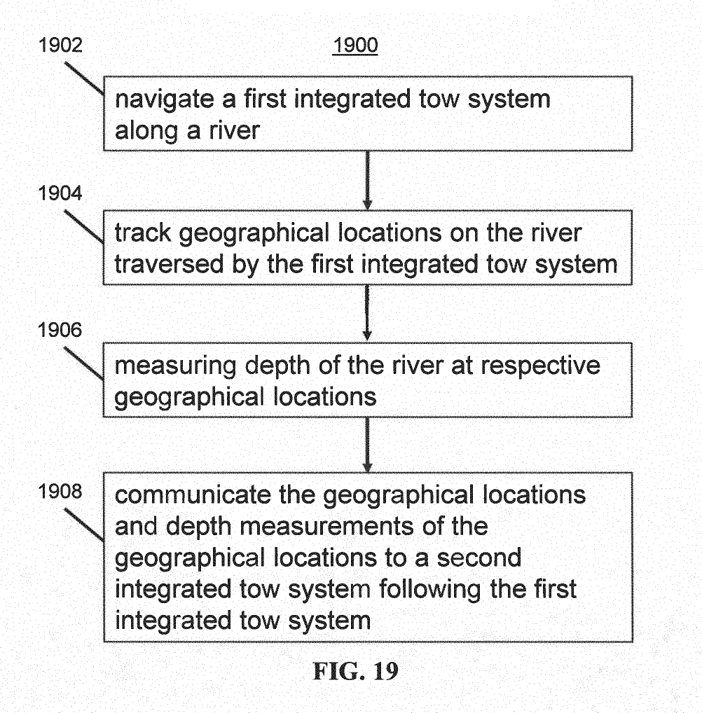

With regard to FIG. 19, an illustration of an illustrative process 1900 for navigating a river is shown. The process 1900 may start at step 1902, where a first integrated tow system may navigate a first tow along the river. At step 1904, geographical locations on the river traversed by the first integrated tow system may be tracked. A controller on the first integrated tow system may generate the safe track. Depth of the river at respective geographical locations may be measured and associated with corresponding geographical locations at step 1906. That is, each of the towboat modules of the integrated tow system may measure depth in a coordinated manner while sampling geographical locations. At step 1908, the geographical locations and depth measurements of the geographical locations may be communicated to a second integrated tow systems subsequently navigating a second tow on the river that enables the second, subsequent integrated tow system to substantially follow the same path as the first integrated tow system. In an embodiment, the communication may be performed by the controller of the first towboat.

In an embodiment, the process may further include tracking geographical locations on the river traversed by the second integrated tow system. The tracking of the second integrated tow system may be performed by the controller of the second integrated tow system. Depth and contour of the river at respective geographical locations may be measured. A controller of the second integrated tow system may communicated the geographical locations and depth measurements of the geographical locations to a third, subsequent integrated tow system navigating the river that enables the third towboat subsequent navigating the river to follow substantially the same path as the second integrated tow system. The communication may occur from the controller via a satellite and remote computing system (e.g., networked server) for further distribution to the third integrated tow system. It should be understood that distribution of depth, contour, and other river (e.g., current) or environmental (e.g., wind speed and direction) may be communicated to multiple integrated tow systems that may be traversing a river section simultaneously, periodically, or aperiodically (e.g., event driven, such as when crossing a geo-curtain) using push or pull distribution techniques.

In an embodiment, differences of depth and contour of the river at the respective geographical locations measured by the first and second integrated tow systems may be determined. If a determination is made that a difference of measured depth or contour crosses a threshold level (e.g., less than 12 feet), a notification warning/alarm may be communicated to other integrated tow system(s) along the same path. Otherwise, no notification of the difference of measured depth or contour may occur. Such difference measurement may be performed to determine if the depth or contour of the river is changing along a path that the integrated tow systems are traveling.

In an embodiment, the navigating by the first integrated tow system includes navigating by (i) a first integrated tow system engaged with the set of barges at a first position and (ii) a second integrated tow system engaged with the set of barges at a second position.

The communication may include communicating to a control computing system that tracks geographical positions, river depths, and river contours of respective integrated tow system, and the control computing system may communicate the geographical locations, river depths, and river contours of the first integrated tow system to the second integrated tow system to support navigation by the second integrated tow system. The communication may be performed via a satellite or via any other communications path(s), as understood in the art. In supporting navigation by the second integrated tow system, the second integrated tow system may be caused to automatically pass through the geographical locations.

In an embodiment, a third integrated tow system may navigate the first tow along the river. A controller on the third integrated tow system may track geographical locations on the river traversed by the third integrated tow system. Depths and contours of the river may be measured at respective geographical locations. In an embodiment, depth sensors are positioned on the outer left and outer right ends of the tow, thereby sensing at a location that would first hit a riverbed. Depth measurement signals may be communicated (1) directly or indirectly, (2) wirelessly or via wire, to a computing system operating on one or more unmanned towboat modules forming the integrated tow system. The controller of the third integrated tow system may communicate the geographical locations and depth and contour measurements of the geographical locations to a fourth integrated tow system subsequently navigating the second tow on the river to enable the fourth, subsequent integrated tow system to follow substantially the same path as the third integrated tow system.

A set of geographical points along the geographical locations on the river traversed by the integrated tow system may be recorded, and the set of geographical points may be communicated to the second, subsequent integrated tow system navigating the river. The set of geographical points may include recording the set of geographical points periodically along a straight portion of the river. The measurement of the geographical points may be varied depending on whether the river is straight or curved. For a curved portion of the river, a higher frequency of measurements may be made than for a straight portion of the river. If the riverbed in an area frequently changes, then the sampling rate of the geographical locations (and depth) may be made more often. Still yet, rather than making periodic measurements, aperiodic measurements (e.g., based on events) may be made. For example, if depth of the river changes abruptly or is much different from a previous measurement by an earlier integrated tow system, then the geographical location determinations may be performed more often to provide higher resolution of riverbed depth.

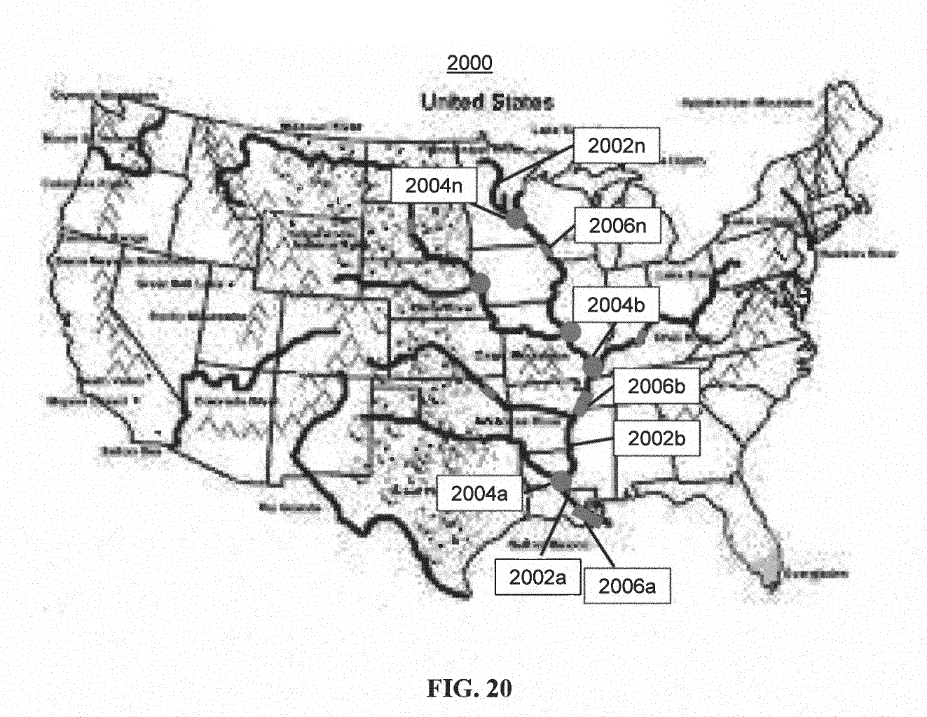

With regard to FIG. 20, an illustration of illustrative map 2000 of rivers in the United States is shown. The rivers include feeder rivers, such as the Illinois River, that flow into major rivers, such as the Mississippi River, are identified as river segments 2002a-2002n (collectively 2002). For the purposes of this description, river segments may include river portions of a river on the same river or different rivers, such as feeder rivers. Between the river segments or river junctions are ports 2004a-2004n (collectively 2004), such as New Orleans, La.; Cairo, Ill.; St. Louis, Miss., and so on, at which barges being transported along the river segments 2002 may be loaded, unloaded, attached to a set of barges, and detached from a set of barges, as understood in the art. In addition, in accordance with the principles described herein, unmanned towboat modules may be exchanged from the set of barges being transported. Within the US, there are currently 30,000 barges and 5,000 towboats.

As understood, there are a number of horsepower requirements on the river segments. For example, the horsepower requirement along the river segments between Panama City, Tex. and Brownsville, Tex. is 2000 hp. The horsepower requirement between New Orleans, La. and Cairo, Ill. is 9000 hp. The horsepower requirement between Cairo, Ill. and West Virginia along the Ohio River is 6000 hp. These geographic considerations limits the ability of different horsepower vessels from operating outside their traditional trades. Moreover, length and width considerations in locking rivers, or areas of restrictive channels limit flexibility in areas of operation. In addition, as the sets of barges move upriver, the number of barges are typically lessened as some of the barges are dropped off at ports along the way and the ability to tow a full set of barges is reduced as the rivers shrink in size.

As shown, sets of barges 2006a-2006n traverse up and down the river segments 2002. As the sets of barges pass through the various ports 2004, the operators drop and add barges. To improve efficiency, the principles described herein with regard to the use of unmanned towboat modules provide scalability depending on the size of the tow, resulting in reduction or increasing number of unmanned towboat modules added to the tow depending on power, maneuverability, and size of the tow for various rivers and river conditions.

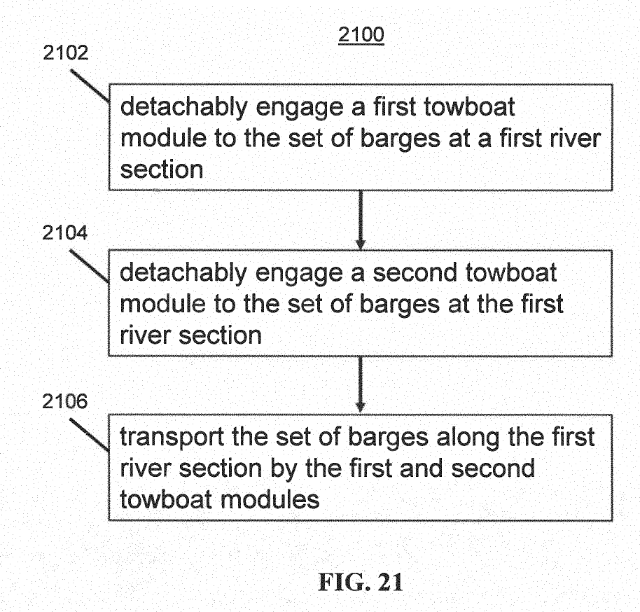

With regard to FIG. 21, a flow diagram of an illustrative process 2100 for transporting a set of barges along a set of river sections or segments is shown. The process 2100 may start at step 2102, where a first unmanned towboat module may be detachably engaged to the set of barges at a first river section. At step 2104, a second unmanned towboat module may be detachably engaged to the set of barges at the first river section. In being detachably engaged, the unmanned towboat modules, which do not have accommodations (e.g., living quarters) for operators, may be attached to the set of barges so as to be able to move the set of barges along the first river section. The tow may be transported along the first river section by the integrated tow system at step 2106 by the first and second unmanned towboat modules. It should be understood that more than two unmanned towboat modules may be utilized. It should be noted that a number of unmanned towboat modules may be used for transporting the set of barges depending on requirements set for safe operation and river conditions.

In furtherance of the process 2100, the first unmanned towboat module may be detached from the set of barges prior to transporting the set of barges along a second section of the river, and the set of barges may be transported along the second river section thereafter. Furthermore, a third unmanned towboat module may be detachably engaged to the set of barges prior to transporting the set of barges along the second section of the river. In an embodiment, the first and third unmanned towboat modules may be detachably engaged to a stern position of the set of barges and the second unmanned towboat module may be detachably engaged to a bow portion of the set of barges.

In an embodiment, the first and third unmanned towboat modules may each have a propulsion unit (e.g., one or more engines) with a first maximum horsepower rating (i.e., the horsepower ratings of each of the propulsion units may be the same, such as 2500 hp). Furthermore, the second unmanned towboat module may have a propulsion unit with a second maximum horsepower rating that is higher than the first maximum horsepower rating. In an alternative embodiment, the second unmanned towboat module may have an engine with a second maximum horsepower rating that is lower than a cumulative horsepower rating of the first and third propulsion units.

In one embodiment, a command module may be detachably engaged to the set of barges. The command module may include (i) living quarters for crew and (ii) a command controller that is configured to communicate with a first controller of the first unmanned towboat module and a second controller of the second unmanned towboat module to respectively control operation of a first propulsion unit of the first unmanned towboat module and a second propulsion unit of the second unmanned towboat module. If the first and second unmanned towboat modules have multiple engines as part of their respective propulsion units, then the command controller may be configured to control each of the multiple engines of each of the unmanned towboat modules.

A third unmanned towboat module and a fourth unmanned towboat module may be detachably coupled to the set of barges at the first river section, and the third unmanned towboat module may be decoupled from the set of barges at a second river section. The fourth unmanned towboat module may be decoupled from the set of barges at a third river section, thereby leaving the first and second unmanned towboat modules still detachably coupled to the remaining set of barges at the river sections. By coupling and decoupling the third and fourth unmanned towboat modules, either at the same time (not simultaneously, but rather prior to towing the set of barges) or at different times, propulsion unit size regulations can be accommodated and provide the horsepower needed to tow the set of barges along appropriate river sections.

In an embodiment, first and second forces, that, when applied to the set of barges by the respective first and second unmanned towboat modules that cause the set of barges to remain in a substantially fixed position on the first river section may be calculated. By substantially fixing the position of the set of barges on the river section, the operator may add/remove cargo and add/remove barges from the set of barges. In addition, unmanned towboat module(s) and a command module may be added or removed from the set of barges without having to beach or otherwise secure the set of barges on the river.

River Park

As previously described with regard to FIG. 13D, a conventional technique for towboat operators to add barges and remove barges from a set of barges or load and unload cargo is to park a tow or set of barges against a shoreline. Several problems result from such a parking, including damaging the shoreline, addressing private property, and impacting the barge(s), just to name a few. In an embodiment, a “river parking” may be performed by causing the towboat(s) and/or unmanned towboat module(s) to maintain a geographical location while connected to the set of barges while freely floating on the river. In an embodiment, the controller system may be configured to utilize various sensor data, including GPS, gyro rotational, accelerometers, and so forth, and provide automatic feedback to cause the thrusters and/or substantially maintain the towboat(s) and/or unmanned towboat module(s) in a fixed position, thereby maintaining the attached set of barges in a substantially fixed position.

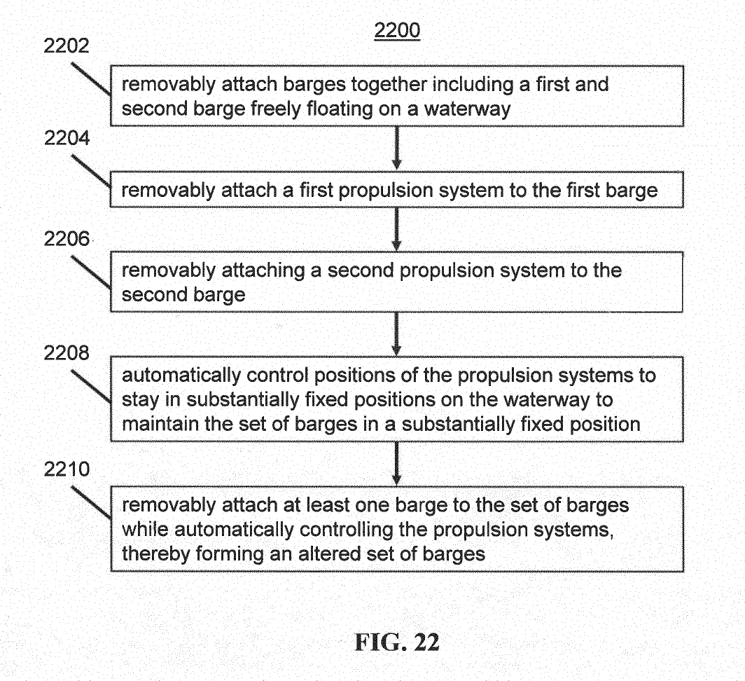

With regard to FIG. 22, a flow diagram of an illustrative process 2200 of forming and altering a configuration of a set of barges is shown. The process 2200 may start at step 2202, where multiple barges may be removably attached together to form a set of barges. The set of barges may include a first barge and a second barge that are freely floating on a waterway (i.e., not anchored, moored, or touching a dock, shoreline, or other fixed position or secured object). At step 2204, a first propulsion system (e.g., unmanned towboat module) may be removably attached to the first barge, and at step 2206 a second propulsion system may be removably attached to the second barge. The propulsion systems may be unmanned towboat modules that are remotely controlled, for example. At step 2208, positions of the first and second propulsion systems may be automatically controlled to maintain the first and second propulsion systems in substantially fixed positions on the waterway, thereby maintaining the set of barges in a substantially fixed position. At step 2210, at least one barge may be removably attached to the set of barges while automatically controlling the first and second propulsion systems, thereby forming an altered set of barges. That is, the set of barges may be altered while the first and second propulsion systems are being maintained in substantially fixed positions.

At least one barge may be detached from the set of barges or the altered set of barges while automatically controlling substantially fixed positions of the first and second propulsion systems. In automatically controlling substantially fixed positions of the first and second propulsion systems, respective forces may be automatically applied to maintain the set of barges or altered set a barges in a substantially fixed position. The automatic application of forces may include applying propulsion forces to counteract motion that is caused by wind, current, or other forces on the set of barges and/or propulsion systems.

Removably attaching the first propulsion system to the first barge may include removably attaching the first propulsion system to the first barge at a stern position of the set of barges. Furthermore, removably attaching the second propulsion system to the second barges may include removably attaching the second propulsion system to the second barge at a bow position of the set of barges. Removably attaching the second propulsion system to the second barge may include removably attaching the second propulsion system to the second barge at a starboard position of the set of barges.

In an embodiment, a third propulsion system may be removably attaching to a third barge. Removably attaching the third propulsion system to the third barge may include removably attaching the third propulsion system to a third barge at a stern of the set of barges. The process may further include detaching the first propulsion system or second propulsion system from the respective first or second barge, moving the first propulsion system or second propulsion system to a third barge in response to forming the altered set of barges, and removably attaching the first propulsion system or second propulsion system to the third barge.

Removably attaching a first propulsion system may include removably attaching a first unmanned towboat module, and removably attaching a second propulsion system may include removably attaching a second unmanned towboat module. In an embodiment, automatically controlling substantially fixed position may include sensing at least one of rotation, acceleration, and position of each of the first and second propulsion systems. Generating thrust vector data for each of the first and second propulsion systems may be based on any of the sensed rotation, acceleration, and position to drive the respective propulsion systems to substantially positionally fix the respective first and second propulsion systems on the waterway. Being substantially fixed may include being maintained in a steady position given environmental factors (e.g., moving within a few feet or less).

The foregoing method descriptions and the process flow diagrams are provided merely as illustrative examples and are not intended to require or imply that the steps of the various embodiments must be performed in the order presented. As will be appreciated by one of skill in the art, the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to and/or in communication with another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description here.

When implemented in software, the functions may be stored as one or more instructions or code on a non-transitory computer-readable or processor-readable storage medium. The steps of a method or algorithm disclosed here may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The previous description is of a preferred embodiment for implementing the invention, and the scope of the invention should not necessarily be limited by this description. The scope of the present invention is instead defined by the following claims.

1. A method of controlling a set of barges, said method comprising:
in response to receiving a rotation command, determining whether the rotation command is to result in a rotational force that exceeds a threshold rotational force, and if not:
calculating a first transverse force to apply to the set of barges from a first location;
calculating a second transverse force to apply to the set of barges from a second location aft of the first location, the first and second transverse forces and corresponding locations defining a first rotation point longitudinally along the set of barges;
applying the first and second transverse forces to the set of barges at the respective first and second locations;
otherwise, if the rotation command is to result in a force that exceeds the threshold rotational force:
recalculating the first and second transverse forces that, if applied to the set of barges, would cause the rotation point to move to a second rotation point; and
applying the recalculated first and second transverse forces to the first and second locations; and
otherwise, continue applying the calculated first and second transverse forces to the set of barges at their respective first and second locations.

2. The method according to claim 1, wherein calculating the first and second transverse forces includes calculating the first and second transverse forces to be in a 1:1 ratio until the rotation command exceeds the threshold rotational force.

3. The method according to claim 2, wherein determining whether the rotational command exceeds the threshold rotational force and includes determining that the rotational command exceeds 80% of available transverse force to be applied at either the first or second locations of the set of barges.

4. The method according to claim 1, wherein determining whether the rotational command exceeds a threshold rotational force is performed periodically.

5. The method according to claim 1, wherein calculating a first transverse force includes calculating a transverse force to be produced at a bow of the set of barges, and wherein calculating a second transverse force includes calculating a transverse force to be produced at a stern of the set of barges.

6. The method according to claim 1, wherein calculating a first transverse force includes calculating a first transverse force based on available transverse force of a bow steering unit, and wherein calculating a second transverse force includes calculating a second transverse force based on available transverse force of a stern steering unit.

7. The method according to claim 1, further comprising enabling an operator to select a curve along which rotation commands are produced by recalculating the first and second transverse forces at the first and second locations.

8. The method according to claim 7, further comprising computing the curve, the curve being non-linear.

9. The method according to claim 1, further comprising monitoring a controller to determine whether an operator has entered a rotation command greater than the threshold rotational force.

10. The method according to claim 1, further comprising calculating a rotation point in response to the rotation command exceeding the threshold rotational force.

11. The method according to claim 10, further comprising repeatedly calculating the rotation point until the rotation command is at or below the threshold rotational force.

12-63. (canceled)

64. A system for controlling a set of barges, said system comprising:
a user interface configured to enable a user to control operation of a towboat; and
an operator computer in communication with the user interface, and configured to receive signals from the user interface and generate commands, the operator computer configured to:
in response to receiving a rotation command signal from the user interface, determine whether the rotation command is to result in a rotational force that exceeds a threshold rotational force, and if not:
calculate a first transverse force to apply to the set of barges from a first location;
calculate a second transverse force to apply to the set of barges from a second location aft of the first location, the first and second transverse forces and corresponding locations defining a first rotation point longitudinally along the set of barges;
apply the first and second transverse forces to the set of barges at the respective first and second locations;
otherwise, if the rotation command is to result in a force that exceeds the threshold rotational force:
recalculate the first and second transverse forces that, if applied to the set of barges, would cause the rotation point to move to a second rotation point; and
apply the recalculated first and second transverse forces to the first and second locations; and
otherwise, continue to apply the calculated first and second transverse forces to the set of barges at their respective first and second locations.

65. The system according to claim 64, wherein the operator computer, in calculating the first and second transverse forces, is configured to calculate the first and second transverse forces to be in a 1:1 ratio until the rotation command exceeds the threshold rotational force.

66. The system according to claim 65, wherein the operator computer, in determining whether the rotational command exceeds the threshold rotational force, is further configured to determine that the rotational command exceeds 80% of available transverse force to be applied at either the first or second locations of the set of barges.

67. The system according to claim 64, wherein the operator computer is configured to periodically determine whether the rotational command exceeds a threshold rotational force.

68. The system according to claim 64, wherein the operator computer, in calculating a first transverse force, is configured to calculate a transverse force to be produced at a bow of the set of barges, and wherein the operator computer, in calculating a second transverse force, is configured to calculate a transverse force to be produced at a stern of the set of barges.

69. The system according to claim 64, wherein the operator computer, in calculating a first transverse force, is configured to calculate a first transverse force based on available transverse force of a bow steering unit, and wherein the operator computer, in calculating a second transverse force, is configured to calculate a second transverse force based on available transverse force of a stern steering unit.

70. The system according to claim 64, wherein the user interface is further configured to enable an operator to select a curve along which rotation commands are produced by recalculating the first and second transverse forces at the first and second locations.

71. The system according to claim 70, wherein the operator computer is configured to compute the curve, the curve being non-linear.

72. The system according to claim 64, wherein the operator computer is configured to determine whether an operator has entered a rotation command greater than the threshold rotational force.

73. The system according to claim 64, wherein the operator computer is configured to calculate a rotation point in response to the rotation command exceeding the threshold rotational force.

74. The system according to claim 73, wherein the operator computer is further configured to repeatedly calculate the rotation point until the rotation command is at or below the threshold rotational force.
